(19) United States
(12) Patent Application Publication
(10) Pub. No.: US 2023/0246192 A1
(43) Pub. Date: Aug. 3, 2023

(54) Elastomer-Protected Anode and Lithium Battery

(71) Applicant: Global Graphene Group, Inc., Dayton, OH (US)

(72) Inventor: Bor Z. Jang, Centerville, OH (US)

(73) Assignee: Global Graphene Group, Inc., Dayton, OH (US)

(21) Appl. No.: 17/649,863

(22) Filed: Feb. 3, 2022

(51) Int. Cl. H01M 4/60; H01M 4/36; H01M 10/44; H01M 10/0525; H01M 4/62

(52) U.S. Cl. CPC H01M 4/60; H01M 4/366; H01M 10/44; H01M 10/0525; H01M 4/624

(57) ABSTRACT

An anode layer for a lithium battery, said anode layer comprising (a) 50% to 95% by weight of multiple anode active material particles; (b) 0.01% to 30% by weight of a conductive additive; and (c) a high-elasticity polymer having a recoverable tensile strain from 5% to 1,000% and a lithium ion conductivity no less than 10⁻⁶ S/cm, wherein the high-elasticity polymer comprises (i) an elastomer or rubber and (ii) a lithium ion-conducting phase comprising plastic crystal and/or organic plasticizer domains containing an optional lithium salt therein, wherein the elastomer or rubber and the lithium ion-conducting phase, separately or in combination, form a network of lithium ion-conducting pathways; the conductive additive forms a network of electron-conducing pathways that are in electrical contact with the anode particles; and the high-elasticity polymer bonds, encapsulates, embraces, or coats on the surfaces of the anode particles and the conductive additive.

### FIELD

The present disclosure relates generally to the field of rechargeable lithium battery and, more particularly, to the elastomer-protected anode and the process for producing same.

### BACKGROUND

A unit cell or building block of a lithium-ion battery is typically composed of an anode current collector, an anode or negative electrode layer (containing an anode active material responsible for storing lithium therein, a conductive additive, and a resin binder), an electrolyte and porous separator, a cathode or positive electrode layer (containing a cathode active material responsible for storing lithium therein, a conductive additive, and a resin binder), and a separate cathode current collector. The electrolyte is in ionic contact with both the anode active material and the cathode active material. A porous separator is not required if the electrolyte is a solid-state electrolyte.

The binder in the binder layer is used to bond the anode active material (e.g. graphite or Si particles) and a conductive filler (e.g. carbon black or carbon nanotube) together to form an anode layer of structural integrity, and to bond the anode layer to a separate anode current collector, which acts to collect electrons from the anode active material when the battery is discharged. In other words, in the negative electrode (anode) side of the battery, there are typically four different materials involved: an anode active material, a conductive additive, a resin binder (e.g., polyvinylidine fluoride, PVDF, or styrene-butadiene rubber, SBR), and an anode current collector (typically a sheet of Cu foil). Typically the former three materials form a separate, discrete anode layer and the latter one forms another discrete layer.

The most commonly used anode active materials for lithium-ion batteries are natural graphite and synthetic graphite (or artificial graphite) that can be intercalated with lithium and the resulting graphite intercalation compound (GIC) may be expressed as LiₓC₆, where x is typically less than 1. The maximum amount of lithium that can be reversibly intercalated into the interstices between graphene planes of a perfect graphite crystal corresponds to x=1, defining a theoretical specific capacity of 372 mAh/g.

Graphite or carbon anodes can have a long cycle life due to the presence of a protective solid-electrolyte interface layer (SEI), which results from the reaction between lithium and the electrolyte (or between lithium and the anode surface/edge atoms or functional groups) during the first several charge-discharge cycles. The lithium in this reaction comes from some of the lithium ions originally intended for the charge transfer purpose. As the SEI is formed, the lithium ions become part of the inert SEI layer and become irreversible, i.e. these positive ions can no longer be shuttled back and forth between the anode and the cathode during charges/discharges. Therefore, it is desirable to use a minimum amount of lithium for the formation of an effective SEI layer. In addition to SEI formation, the irreversible capacity loss Qᵢᵣ can also be attributed to graphite exfoliation caused by electrolyte/solvent co-intercalation and other side reactions.

In addition to carbon- or graphite-based anode materials, other inorganic materials that have been evaluated for potential anode applications include metal oxides, metal nitrides, metal sulfides, and the like, and a range of metals, metal alloys, and intermetallic compounds that can accommodate lithium atoms/ions or react with lithium. Among these materials, lithium alloys having a composition formula of LiₐA (A is a metal or semiconductor element, such as Al and Si, and “a” satisfies 0<a≤5) are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as schematically illustrated in FIG. 2(A), in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.

To overcome the problems associated with such mechanical degradation, three technical approaches have been proposed:
(1) reducing the size of the active material particle, presumably for the purpose of reducing the total strain energy that can be stored in a particle, which is a driving force for crack formation in the particle. However, a reduced particle size implies a higher surface area available for potentially reacting with the liquid electrolyte to form a higher amount of SEI. Such a reaction is undesirable since it is a source of irreversible capacity loss.
(2) depositing the electrode active material in a thin film form directly onto a current collector, such as a copper foil. However, such a thin film structure with an extremely small thickness-direction dimension (typically much smaller than 500 nm, often necessarily thinner than 100 nm) implies that only a small amount of active material can be incorporated in an electrode (given the same electrode or current collector surface area), providing a low total lithium storage capacity and low lithium storage capacity per unit electrode surface area (even though the capacity per unit mass can be large). Such a thin film must have a thickness less than 100 nm to be more resistant to cycling-induced cracking, further diminishing the total lithium storage capacity and the lithium storage capacity per unit electrode surface area. Such a thin-film battery has very limited scope of application. A desirable and typical electrode thickness is from 100 μm to 200 μm. These thin-film electrodes (with a thickness of <500 nm or even <100 nm) fall short of the required thickness by three (3) orders of magnitude, not just by a factor of 3.
(3) using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nano particles. Presumably, the protective matrix provides a cushioning effect for particle expansion or shrinkage, and prevents the electrolyte from contacting and reacting with the electrode active material. Examples of high-capacity anode active particles are Si, Sn, and SnO₂. Unfortunately, when an active material particle, such as Si particle, expands (e.g., up to a volume expansion of 380%) during the battery charge step, the protective coating is easily broken due to the mechanical weakness and/o brittleness of the protective coating materials. There has been no high-strength and high-toughness material available that is itself also lithium ion conductive.

It may be further noted that the coating or matrix materials used to protect active particles (such as Si and Sn) are carbon, sol gel graphite, metal oxide, monomer, ceramic, and lithium oxide. These protective materials are all very brittle, weak (of low strength), and/or non-conducting (e.g., ceramic or oxide coating). Ideally, the protective material should meet the following requirements: (a) The coating or matrix material should be of high strength and stiffness so that it can help to refrain the electrode active material particles, when lithiated, from expanding to an excessive extent. (b) The protective material should also have high fracture toughness or high resistance to crack formation to avoid disintegration during repeated cycling. (c) The protective material must be inert (inactive) with respect to the electrolyte, but be a good lithium ion conductor. (d) The protective material must not provide any significant amount of defect sites that irreversibly trap lithium ions. (e) The protective material must be lithium ion-conducting as well as electron-conducting. The prior art protective materials all fall short of these requirements. Hence, it was not surprising to observe that the resulting anode typically shows a reversible specific capacity much lower than expected. In many cases, the first-cycle efficiency is extremely low (mostly lower than 80% and some even lower than 60%). Furthermore, in most cases, the electrode was not capable of operating for a large number of cycles. Additionally, most of these electrodes are not high-rate capable, exhibiting unacceptably low capacity at a high discharge rate.

Due to these and other reasons, most of prior art composite electrodes and electrode active materials have deficiencies in some ways, e.g., in most cases, less than satisfactory reversible capacity, poor cycling stability, high irreversible capacity, ineffectiveness in reducing the internal stress or strain during the lithium ion insertion and extraction steps, and other undesirable side effects.

Complex composite particles of particular interest are a mixture of separate Si and graphite particles dispersed in a carbon matrix; e.g., those prepared by Mao, et al. [“Carbon-coated Silicon Particle Powder as the Anode Material for Lithium Batteries and the Method of Making the Same,” US 2005/0136330 (Jun. 23, 2005)]. Also of interest are carbon matrix-containing complex nano Si (protected by oxide) and graphite particles dispersed therein, and carbon-coated Si particles distributed on a surface of graphite particles Again, these complex composite particles led to a low specific capacity or for up to a small number of cycles only. It appears that carbon by itself is relatively weak and brittle and the presence of micron-sized graphite particles does not improve the mechanical integrity of carbon since graphite particles are themselves relatively weak. Graphite was used in these cases presumably for the purpose of improving the electrical conductivity of the anode material. Furthermore, polymeric carbon, amorphous carbon, or pre-graphitic carbon may have too many lithium-trapping sites that irreversibly capture lithium during the first few cycles, resulting in excessive irreversibility.

In summary, the prior art has not demonstrated an anode electrode having a high-capacity anode active material that has all or most of the properties desired for use in a lithium-ion battery. Thus, there is an urgent and continuing need for a new anode that enables a lithium-ion battery to exhibit a high cycle life, high reversible capacity, low irreversible capacity, and compatibility with commonly used electrolytes. There is also a need for a method of readily or easily producing such an anode.

Thus, it is an object of the present invention to meet these needs and address the issues associated the rapid capacity decay of a lithium battery containing a high-capacity anode active material.

### SUMMARY

The present disclosure provides an anode active material layer for a lithium battery. In certain embodiments, the anode active material layer comprises: (a) 50% to 95% by weight of multiple anode active material particles; (b) 0.01% to 30% by weight of a conductive additive; and (c) a high-elasticity polymer having a recoverable tensile strain from 5% to 1,000% when measured without an additive or reinforcement in the polymer and a lithium ion conductivity no less than 10⁻⁶ S/cm at room temperature, wherein the high-elasticity polymer comprises (i) an elastomer or rubber and (ii) a lithium ion-conducting phase comprising plastic crystal domains and/or organic plasticizer domains containing an optional lithium salt dispersed or dissolved therein, wherein: (1) the elastomer or rubber and the lithium ion-conducting phase, separately or in combination, form a network of lithium ion-conducting pathways; (2) the amount of conductive additive is sufficient to form a network of electron-conducing pathways that are in electrical contact with the anode active material particles; and (3) the high-elasticity polymer bonds, encapsulates, embraces, or coats on the surfaces of the anode active material particles and the conductive additive so as to maintain the structural integrity of the anode electrode, preventing interruption of the electron- and lithium ion-conducting pathways when the anode active material particles repeatedly expand and shrink in volume during battery cycling.

The word “elastomer” and the word “rubber” will be used interchangeably in the instant specification. The high-elasticity polymer forms a continuous material phase that substantially embraces the anode material particles and the conductive additive (e.g., CNTs, graphene sheets, carbon black particles, etc.). Being a continuous phase that is ion-conducting, the high-elasticity polymer provides robust lithium ion-conducting pathways. The amount of conductive additive is preferably sufficient to form a 3D network of electron-conducing pathways that are in electrical contact with the anode material particles.

The high-elasticity polymer preferably has a recoverable tensile strain typically from 5% to 700% and more typically from 10% to 300%, when measured without an additive or reinforcement. The polymer (elastomer or rubber) preferably has a lithium ion conductivity no less than 10⁻⁶ S/cm (preferably >10⁻⁵ S/cm, further preferably >10⁻⁴ S/cm, and more preferably >10⁻³ S/cm) when measured at room temperature.

In certain embodiments, the elastomer or rubber is selected from natural polyisoprene, synthetic polyisoprene, polybutadiene, chloroprene rubber, polychloroprene, butyl rubber, butyl acrylic rubber, styrene-butadiene rubber, nitrile rubber, ethylene propylene rubber, ethylene propylene diene rubber, epichlorohydrin rubber, polyacrylic rubber, silicone rubber or polysiloxane, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyurethane, urethane-urea copolymer, poly(phosphazene), a copolymer thereof, a chemically substituted version thereof, a chemical derivative thereof, a sulfonated version thereof, or a combination thereof.

The elastomer or rubber may be selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

In some embodiments, the high-elasticity polymer contains a lithium salt dispersed or dissolved in the elastomer (or rubber) and/or in the lithium ion-conducting phase. Preferably, the high-elasticity polymer comprises from 5% to 95% by weight of a lithium ion-conducting phase (plastic crystal domains and/or organic plasticizer domains) dispersed in or connected to the elastomer or rubber. Preferably, the proportion of the lithium ion-conducting phase is from 25% to 75%, more preferably from 35% to 65%, further preferably from 45% to 65%, and most preferably 50%. In some preferred embodiments, the elastomer (or rubber) and the plastic crystal or organic plasticizer domain form co-continuous phases exhibiting a lithium-ion conductivity no less than 10⁻⁵ S/cm.

The high-elasticity elastic polymer may further comprise from 0.1% to 80% by weight of a lithium ion-conducting material dispersed or dissolved in the high-elasticity polymer. The lithium ion-conducting material may comprise a lithium salt selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

In some embodiments, the lithium ion-conducting material is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

In certain embodiments, the high-elasticity polymer forms a mixture, blend, copolymer, crosslinked network, or interpenetrating network with a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

A high-elasticity polymer refers to a polymer, typically a lightly cross-linked polymer, which exhibits an elastic deformation that is at least 2% (preferably at least 5%) when measured under uniaxial tension. In the field of materials science and engineering, the “elastic deformation” is defined as a deformation of a material (when being mechanically stressed) that is essentially fully recoverable upon release of the load and the recovery process is essentially instantaneous (no or little time delay). The elastic deformation is more preferably greater than 10%, even more preferably greater than 30%, further more preferably greater than 50%, and still more preferably greater than 100%. The elasticity of the elastic polymer alone (without any additive dispersed therein) can be as high as 1,000%. However, the elasticity can be significantly reduced if a certain amount of inorganic filler is added into the polymer. Depending upon the type and proportion of the solid electrolyte particles incorporated, the reversible elastic deformation is typically reduced to the range of 2%-500%, more typically 2%-300%.

In some preferred embodiments, the high-elasticity polymer contains a lightly cross-linked network of polymer chains having an ether linkage, nitrile-derived linkage, benzo peroxide-derived linkage, ethylene oxide linkage, ethylene glycol linkage (e.g., ethylene glycol diacrylate chains), propylene oxide linkage, vinyl alcohol linkage, cyano-resin linkage, triacrylate monomer-derived linkage, tetraacrylate monomer-derived linkage, or a combination thereof, in the cross-linked network of polymer chains having a degree of crosslinking that affords an elasticity of the polymer in the range from 5% to 1,000%. These network or cross-linked polymers exhibit a unique combination of a high elasticity (high elastic deformation strain) and high lithium-ion conductivity.

In certain preferred embodiments, the high-elasticity polymer contains a lightly cross-linked network polymer chains selected from nitrile-containing polyvinyl alcohol chains, cyanoresin chains, pentaerythritol tetraacrylate (PETEA) chains, pentaerythritol triacrylate chains, ethoxylated trimethylolpropane triacrylate (ETPTA) chains, ethylene glycol methyl ether acrylate (EGMEA) chains, poly(ethylene glycol) diacrylate (PEGDA) chains, acrylic acid-derived chains, polyvinyl alcohol chains, or a combination thereof.

In certain desired embodiments, the high-elasticity polymer in the separator comprises from 5% to 95% by weight (preferably from 25% to 75%, more preferably from 35% to 65%, and most preferably from 45% to 55%) of a lithium ion-conducting plastic crystal or organic domain phase dispersed in or connected to the high-elasticity polymer. Preferably, the high-elasticity polymer and the plastic crystal phase or organic domain form co-continuous phases exhibiting a lithium-ion conductivity no less than 10⁻⁵ S/cm. These high-elasticity polymers elastomers can be used for lithium metal batteries, lithium air batteries, lithium-sulfur batteries, and lithium-selenium batteries.

The plastic crystal or organic domain phase typically and desirably comprises a mixture of a lithium salt and a lithium ion conducting organic species. These organic species preferably have a relatively high dielectric constant (preferably >5, more preferably >20, and further preferably >50) that is conducive to dissolving a suitable amount of a lithium salt. The mixture must also have chemical compatibility with the crosslinked network of chains of the elastic polymer and can be readily impregnate into the nano-scaled spaces between these chains. The organic species may be in the form of an oligomer or low molecular weight polymer having a number average molecular weight preferably less than 10,000 g/mole.

The desirable organic species in the plastic crystal/organic domain phase may be selected from a fluorinated carbonate, hydrofluoroether, fluorinated vinyl carbonate, fluorinated ester, fluorinated vinyl ester, fluorinated vinyl ether, sulfone, sulfide, nitrile (dinitrile), succino-nitrile, acrylonitrile, sulfate, siloxane, silane, phosphate, phosphonate, phosphinate, phosphine, phosphine oxide, phosphonic acid, phosphorous acid, phosphite, phosphoric acid, phosphazene compound, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfolane, acetonitrile, acrylonitrile, fluoroethylene carbonate (FEC), an ionic liquid solvent, a polymerized version thereof, or a combination thereof. The polymerized versions of these polymers preferably have a low molecular weight, having a number average molecular weight preferably less than 10,000 g/mole (more preferably <5,000 g/mole and further more preferably <2,000 g/mole).

The sulfone or sulfide is selected from vinyl sulfone, allyl sulfone, alkyl vinyl sulfone, aryl vinyl sulfone, vinyl sulfide, a vinyl-containing variant of TrMS, MTrMS, TMS, EMS, MMES, EMES, EMEES, or a combination thereof:

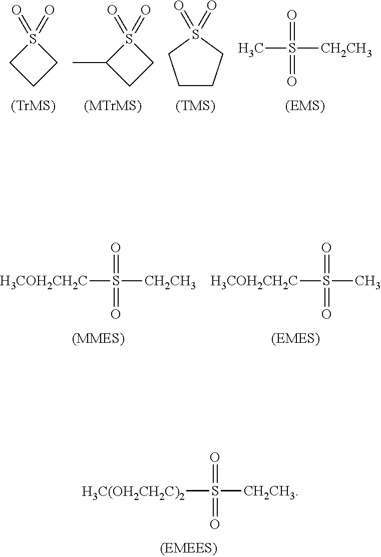

The vinyl sulfone or sulfide may be selected from ethyl vinyl sulfide, allyl methyl sulfide, phenyl vinyl sulfide, phenyl vinyl sulfoxide, allyl phenyl sulfone, allyl methyl sulfone, divinyl sulfone, or a combination thereof, wherein the vinyl sulfone does not include methyl ethylene sulfone and ethyl vinyl sulfone.

The nitrile preferably comprises a dinitrile or is selected from AND, GLN, SEN, succino-nitrile, or a combination thereof:

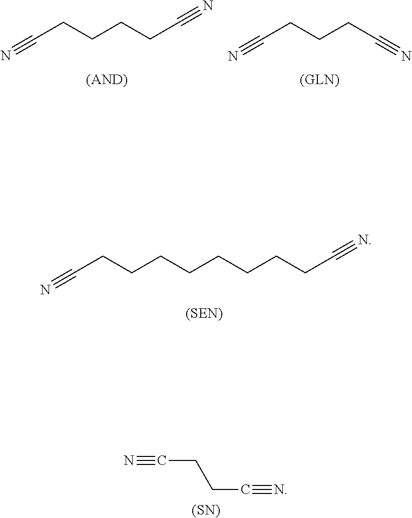

The phosphate may be selected from allyl-type, vinyl-type, styrenic-type and (meth)acrylic-type monomers bearing a phosphonate moiety. The phosphate, phosphonate, phosphonic acid, phosphazene, or phosphite may be selected from TMP, TEP, TFP, TDP, DPOF, DMMP, DMMEMP, tris(trimethylsilyl)phosphite (TTSPi), alkyl phosphate, triallyl phosphate (TAP), a combination thereof, wherein TMP, TEP, TFP, TDP. DPOF DMMP, DMMEMP, and phosphazene have the following chemical formulae:

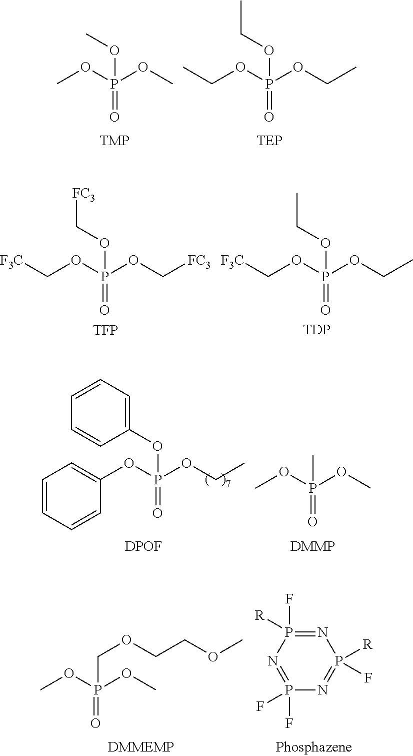

wherein R═H, NH₂, or C₁-C₆ alkyl.
   The siloxane or silane may be selected from alkylsiloxane (Si—O), alkyylsilane (Si—C), liquid oligomeric silaxane (—Si—O—Si—), or a combination thereof.

In some embodiments, the high-elasticity polymer contains a network of chains that are crosslinked by a crosslinking agent to a desired degree of crosslinking that imparts an elastic tensile strain from 5% to 500%.

The crosslinking agent may be selected from methyl benzoylformate, N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKH-A), glycerol diglycidyl ether (GDE), ethylene glycol, polyethylene glycol, polyethylene glycol diglycidyl ether (PEGDE), citric acid, acrylic acid, methacrylic acid, a derivative compound of acrylic acid, a derivative compound of methacrylic acid (e.g. polyhydroxyethylmethacrylate), glycidyl functions, N,N′-Methylenebisacrylaminide (MBAAm), Ethylene glycol dimethacrylate (EGDMAAm), isobornyl methacrylate, poly (acrylic acid) (PAA), methyl methacrylate, isobornyl acrylate, ethyl methacrylate, isobutyl methacrylate, n-Butyl methacrylate, ethyl acrylate, 2-Ethyl hexyl acrylate, n-Butyl acrylate, a chemical derivative thereof, a diisocyanate, an urethane chain, or a combination thereof.

In some composite particulates, the chemically substituted version comprises a H atom being substituted with an alkali cation selected from Li⁺, Na⁺, K⁺, or NH₄⁺.

In certain desired embodiments, the high-elasticity polymer contains a cross-linked network of polymer chains, a semi-interpenetrating network (semi-IPN containing one cross-linked network and a non-crosslinked polymer), or a simultaneous interpenetrating network (SIPN, containing two comingled networks of cross-linked polymer chains).

Preferably, the high-elasticity polymer has a crosslinking ratio from about 0.1% to 70%. This indicates the proportion of cross-linkable functional groups in a starting polymer that have been actually crosslinked after curing.

In the field of materials science and engineering, the “elastic deformation” is defined as a deformation of a material (when being mechanically stressed) that is essentially fully recoverable upon release of the load and the recovery is essentially instantaneous. A high-elasticity polymer refers to a lightly cross-linked elastomer or rubber, which exhibits an elastic deformation that is at least 5% when measured (without an additive or reinforcement in the polymer) under uniaxial tension. The elastic deformation is preferably greater than 30%, more preferably greater than 50%, further more preferably greater than 100%, still more preferably greater than 150%, and most preferably greater than 200%. It can reach 1,500%, but typically less than 1,000%.

In certain embodiments, the anode active material layer contains from 0.01% to 30% by weight of a conductive additive; e.g., those selected from graphite, graphene, or carbon material dispersed therein. The graphite, graphene, or carbon material is preferably selected from polymeric carbon, amorphous carbon, chemical vapor deposition carbon, coal tar pitch, petroleum pitch, meso-phase pitch, carbon black, coke, acetylene black, activated carbon, graphite particles, carbon particles, meso-phase microbeads, carbon or graphite fibers, carbon nanotubes (CNTs), carbon nano-fibers, graphitic nano-fibers, graphene sheets, or a combination thereof and the graphite, graphene, or carbon material forms a 3D network of electron-conducting pathways. The 3D network of electron-conducting pathways is in electronic or physical contacts with the anode material particles.

The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, P, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles; (g) prelithiated versions thereof; (h) particles of lithium metal or lithium metal alloy; and (i) combinations thereof.

In some embodiments, the anode active material contains a prelithiated Si, prelithiated Ge, prelithiated Sn, prelithiated SnOₓ, prelithiated SiOₓ, prelithiated iron oxide, prelithiated V₂O₅, prelithiated V₃O₈, prelithiated Co₃O₄, prelithiated Ni₃O₄, or a combination thereof, wherein x=1 to 2.

It may be noted that pre-lithiation of an anode active material means that this material has been pre-intercalated by or doped with lithium ions up to a weight fraction from 0.1% to 54.7% of Li in the lithiated product.

In some embodiments, the anode active material may be in a form of nano particle (spherical, ellipsoidal, and irregular shape), nano wire, nano fiber, nano tube, nano sheet, nano belt, nano ribbon, nano disc, nano platelet, or nano horn having a thickness or diameter less than 100 nm. These shapes can be collectively referred to as “particles” unless otherwise specified or unless a specific type among the above species is desired. In some embodiments, the anode active material has a dimension less than 50 nm, less than 20 nm, or less than 10 nm.

In some embodiments, the anode active material particles (primary particles) contain sub-micron or micron-scale particles that have a thickness or diameter from 100 nm to 50 μm, preferably less than 10 μm, and more preferably less than 2 μm.

The primary particles can be porous, having pores to accommodate volume expansion of the primary particles, such as Si particles that can undergo a volume expansion up to 380%. The anode active material layer may be designed and built to contain therein from 10% to 70% by volume of pores.

In some embodiments, a cluster of primary particles may be totally embedded in, engulfed by, and dispersed in a matrix of a high-elasticity polymer wherein the polymer forms a continuous phase (hence, the term “matrix”) and the primary particles are a dispersed or discrete phase. In some embodiments, a carbon layer may be deposited to embrace or encapsulate the primary particles prior to being dispersed in the polymer matrix.

The particulate may further contain a graphite, graphene, and/or carbon material dispersed in the high-elasticity polymer. The carbon or graphite material may be selected from polymeric carbon, amorphous carbon, chemical vapor deposition carbon, coal tar pitch, petroleum pitch, meso-phase pitch, carbon black, coke, acetylene black, activated carbon, fine expanded graphite particle with a dimension smaller than 100 nm, artificial graphite particle, natural graphite particle, carbon nano-tubes (single-walled or multi-walled), carbon nano-fibers (vapor-grown or carbonized polymer fibers), graphitic nano-fibers, graphene sheets, or a combination thereof. Graphene may be selected from pristine graphene, graphene oxide, reduced graphene oxide, graphene fluoride, hydrogenated graphene, nitrogenated graphene, functionalized graphene, etc.

The carbon/graphite/graphene particles, fibers, nanotubes, and/or nano sheets dispersed in the high-elasticity polymer preferably and typically constitute a 3D network of electron-conducting paths that preferably are in contact with individual primary particles of the anode active material. The high-elasticity polymer matrix, being a continuous phase and making contact with individual primary particles (being substantially totally immersed in the polymer matrix) provide a 3D network of lithium ion-conducting paths. In other words, there are dual networks of conducting pathways for electrons and lithium ions inside the multi-functional composite particulate.

Preferably and typically, the high-elasticity polymer has a lithium ion conductivity no less than 10⁻⁶ S/cm, more preferably no less than 10⁻⁵ S/cm, and most preferably no less than 10⁻⁴ S/cm. Some of the selected polymers exhibit a lithium-ion conductivity greater than 10⁻³ S/cm. In some embodiments, the high-elasticity polymer is a neat elastomer or rubber containing no additive or filler dispersed therein. In others, the high-elasticity polymer is polymer matrix composite containing from 0.1% to 50% by weight (preferably from 1% to 35% by weight) of a lithium ion-conducting additive dispersed in a high-elasticity polymer matrix material.

In some embodiments, the high-elasticity polymer comprises a blend, copolymer, crosslinked network, or interpenetrating network between the elastomer (or rubber) and an electron-conducting polymer comprising chains of a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof. The high-elasticity polymer may preferably form a mixture or blend with an electron-conducting polymer selected from polyaniline, polypyrrole, polythiophene, polyfuran, a bi-cyclic polymer, derivatives thereof (e.g., sulfonated versions), or a combination thereof.

The present disclosure also provides a lithium battery containing an optional anode current collector, the presently invented anode layer as described above, a cathode active material layer, an optional cathode current collector, an electrolyte in ionic contact with the anode active material layer and the cathode active material layer and an optional porous separator. The lithium battery may be a lithium-ion battery, lithium metal battery (containing lithium metal or lithium alloy as the main anode active material and containing no intercalation-based anode active material), lithium-sulfur battery, lithium-selenium battery, or lithium-air battery.

In certain embodiments, the disclosure provides a method of producing an anode electrode, the method comprising: (a) dispersing multiple primary particles of an anode active material, a conductive additive, and a resin binder in a liquid medium to form a slurry; (b) forming the slurry onto at least a surface of an anode current collector and removing the liquid medium to form at least an anode layer bonded to the anode current collector, wherein the anode layer is porous containing pores; (c) preparing a reactive liquid solution comprising (i) a monomer with an initiator or a cross-linkable oligomer, or a polymer with a cross-linking agent and (ii) a desired amount of an organic plasticizer or plastic crystal precursor, and impregnating the reactive liquid solution into pores of the porous anode layer; and (d) polymerizing the monomer and/or cross-linking the oligomer or polymer to form a high-elasticity polymer comprising an elastomer/rubber and a lithium ion-conducting phase, wherein the high-elasticity polymer embraces the primary particles of the anode active material and the conductive additive to form the anode active layer.

The reactive liquid solution may further comprise a diluent or plasticizer, preferably selected from the group consisting of bis(2-methoxyethyl) ether, sulfones, sulfides, nitriles, dinitriles, succino-nitriles, acrylonitrile (AN), sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

In some embodiments, the disclosure provides a method of producing the anode active layer described above, the method comprising: (a) dispersing multiple primary particles of an anode active material, a conductive additive, and a resin binder in a liquid medium to form a slurry; (b) forming the slurry onto at least a surface of an anode current collector and removing the liquid medium to form at least an anode layer bonded to the anode current collector, wherein the anode layer is porous containing pores therein; (c) preparing a liquid solution comprising a thermoplastic elastomer and an organic plasticizer dissolved or dispersed in a liquid solvent, and impregnating the liquid solution into pores of the porous anode layer; and (d) removing the liquid solvent to precipitate out a high-elasticity polymer comprising the thermoplastic elastomer and domains of plastic crystal or organic plasticizer, wherein the high-elasticity polymer embraces the primary particles of the anode active material and the conductive additive to form the anode active layer.

The present disclosure further discloses a method of producing an anode electrode, the method comprising: (A) dispersing multiple primary particles of an anode active material and a conductive additive in a reactive liquid solution to form a slurry, wherein the reactive liquid solution comprises a plasticizer or plastic crystal precursor and a monomer with an initiator or a cross-linkable oligomer or polymer with a cross-linking agent; (B) forming the slurry onto at least a surface of an anode current collector to form at least a reactive layer comprising the monomer with an initiator or the cross-linkable oligomer or polymer with a cross-linking agent; and (C) polymerizing the monomer or cross-linking the oligomer or polymer to form a high-elasticity polymer that embraces the primary particles of the anode active material and the conductive additive to form the active anode material layer.

### BRIEF DESCRIPTION OF THE DRAWINGS

FIG. 1(A) Schematic of a prior art lithium-ion battery cell, wherein the anode layer is a thin coating of an anode active material itself.

FIG. 1(B) Schematic of another prior art lithium-ion battery; the anode layer being composed of particles of an anode active material, a conductive additive (not shown) and a resin binder (not shown).

FIG. 2(A) Schematic illustrating the notion that expansion of Si particles, upon lithium intercalation during charging of a prior art lithium-ion battery, can lead to pulverization of Si particles, interruption of the conductive paths formed by the conductive additive, and loss of contact with the current collector;

FIG. 2(B) illustrates the issues associated with prior art anode active material; for instance, a non-lithiated Si particle encapsulated by a protective shell (e.g., carbon shell) in a core-shell structure inevitably leads to breakage of the shell and that a pre-lithiated Si particle encapsulated with a protective layer leads to poor contact between the contracted Si particle and the rigid protective shell during battery discharge.

FIG. 3 Schematic of some examples of porous primary particles.

FIG. 4(A) A flow chart illustrating a method of producing an anode electrode according to certain embodiments of the present disclosure.

FIG. 4(B) Another flow chart illustrating another method of producing an anode electrode according to certain embodiments of the present disclosure.

FIG. 4(C) Schematic of an anode electrode comprising elastomer matrix-protected anode particles and conductive additive (e.g., CNTs or graphene sheets) according to certain embodiments of the present disclosure.

### DESCRIPTION OF THE PREFERRED EMBODIMENTS

This disclosure provides an anode (negative electrode) comprising multiple anode active material particles dispersed or embedded in a high-elasticity polymer matrix for a lithium secondary battery, which is preferably a secondary battery based on a non-aqueous electrolyte, a polymer gel electrolyte, an ionic liquid electrolyte, a quasi-solid electrolyte, a polymer solid electrolyte, an inorganic solid-state electrolyte, or a composite or hybrid electrolyte. The shape of a lithium secondary battery can be cylindrical, square, button-like, etc. The present disclosure is not limited to any battery shape or configuration or any type of electrolyte. For convenience, we will primarily use Si, Sn, and SnO₂ as illustrative examples of a high-capacity anode active material. This should not be construed as limiting the scope of the invention.

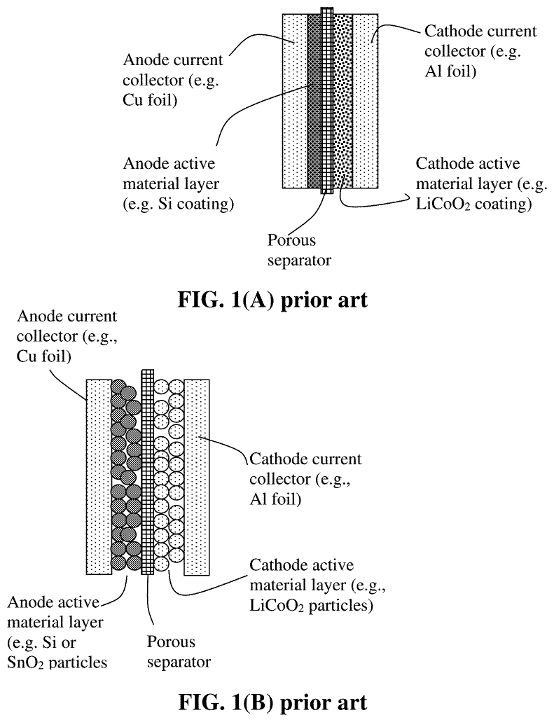

As illustrated in FIG. 1(B), a lithium-ion battery cell is typically composed of an anode current collector (e.g. Cu foil), an anode or negative electrode active material layer (i.e. anode layer typically containing particles of an anode active material, conductive additive, and binder), a porous separator and/or an electrolyte component, a cathode or positive electrode active material layer (containing a cathode active material, conductive additive, and resin binder), and a cathode current collector (e.g. Al foil). More specifically, the anode layer is composed of particles of an anode active material (e.g. graphite, Sn, SnO₂, or Si), a conductive additive (e.g. carbon black particles), and a resin binder (e.g. SBR or PVDF). This anode layer is typically 50-300 μm thick (more typically 100-200 μm) to give rise to a sufficient amount of current per unit electrode area.

In a less commonly used cell configuration, as illustrated in FIG. 1(A), the anode active material is deposited in a thin film form directly onto an anode current collector, such as a layer of Si coating deposited on a sheet of copper foil. This is not commonly used in the battery industry and, hence, will not be discussed further.

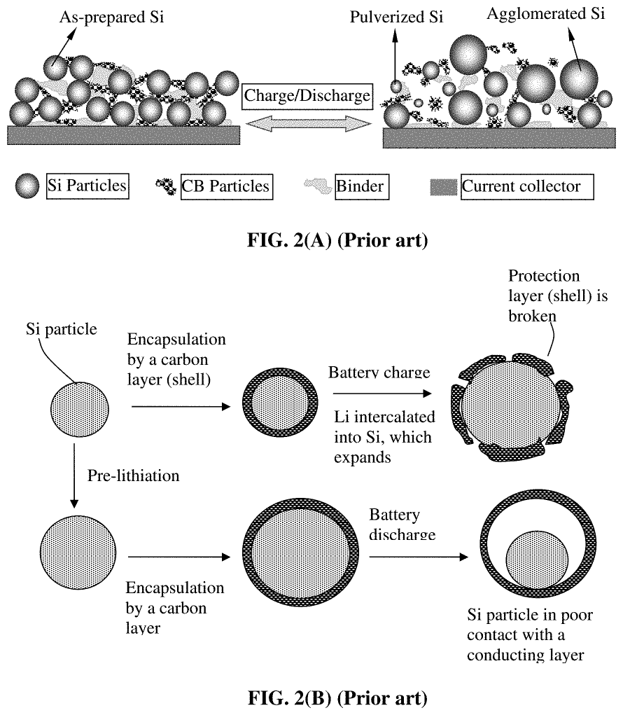

In order to obtain a higher energy density cell, the anode in FIG. 1(B) can be designed to contain higher-capacity anode active materials having a composition formula of LiₐA (A is a metal or semiconductor element, such as Al and Si, and “a” satisfies 0<a≤5). These materials are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as discussed in the Background section, there are several problems associated with the implementation of these high-capacity anode active materials:
1) As schematically illustrated in FIG. 2(A), in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.
2) The approach of using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nano particles, has failed to overcome the capacity decay problem. Presumably, the protective matrix provides a cushioning effect for particle expansion or shrinkage, and prevents the electrolyte from contacting and reacting with the electrode active material.

Unfortunately, when an active material particle, such as Si particle, expands (e.g. up to a volume expansion of 380%) during the battery charge step, the protective coating is easily broken due to the mechanical weakness and/o brittleness of the protective coating materials.

There has been no high-strength and high-toughness material available that is itself also lithium ion conductive.
3) The approach of using a core-shell structure (e.g., Si nano particle encapsulated in a carbon or SiO₂ shell) also has not solved the capacity decay issue. As illustrated in upper portion of FIG. 2(B), a non-lithiated Si particle can be encapsulated by a carbon shell to form a core-shell structure (Si core and carbon or SiO₂ shell in this example). As the lithium-ion battery is charged, the anode active material (carbon- or SiO₂-encapsulated Si particle) is intercalated with lithium ions and, hence, the Si particle expands. Due to the brittleness of the encapsulating shell (carbon), the shell is broken into segments, exposing the underlying Si to electrolyte and subjecting the Si to undesirable reactions with electrolyte during repeated charges/discharges of the battery. These reactions continue to consume the electrolyte and reduce the cell's ability to store lithium ions.
4) Referring to the lower portion of FIG. 2(B), wherein the Si particle has been pre-lithiated with lithium ions; i.e. has been pre-expanded in volume. When a layer of carbon (as an example of a protective material) is encapsulated around the pre-lithiated Si particle, another core-shell structure is formed. However, when the battery is discharged and lithium ions are released (de-intercalated) from the Si particle, the Si particle contracts, leaving behind a large gap between the protective shell and the Si particle. Such a configuration is not conducive to lithium intercalation of the Si particle during the subsequent battery charge cycle due to the gap and the poor contact of Si particle with the protective shell (through which lithium ions can diffuse). This would significantly curtail the lithium storage capacity of the Si particle particularly under high charge rate conditions.

In other words, there are several conflicting factors that must be considered concurrently when it comes to the design and selection of an anode active material in terms of material type, shape, size, porosity, and electrode layer thickness. Thus far, there has been no effective solution offered by any prior art teaching to these conflicting problems. We have solved these challenging issues that have troubled battery designers and electrochemists alike for more than 30 years by developing the high-elasticity polymer encapsulation and protection layer technology.

The present disclosure provides an anode active material layer for a lithium battery. In certain embodiments, the anode active material layer comprises: (a) 50% to 95% by weight of multiple anode active material particles; (b) 0.01% to 30% by weight of a conductive additive; and (c) a high-elasticity polymer having a recoverable tensile strain from 5% to 1,000% when measured without an additive or reinforcement in the polymer and a lithium ion conductivity no less than 10⁻⁶ S/cm at room temperature, wherein the high-elasticity polymer comprises (i) an elastomer or rubber and (ii) a lithium ion-conducting phase comprising plastic crystal domains and/or organic plasticizer domains containing an optional lithium salt dispersed or dissolved therein, wherein: (1) the elastomer or rubber and the lithium ion-conducting phase, separately or in combination, form a network of lithium ion-conducting pathways; (2) the amount of conductive additive is sufficient to form a network of electron-conducing pathways that are in electrical contact with the anode active material particles; and (3) the high-elasticity polymer bonds, encapsulates, embraces, or coats on the surfaces of the anode active material particles and the conductive additive so as to maintain the structural integrity of the anode electrode, preventing interruption of the electron- and lithium ion-conducting pathways when the anode active material particles repeatedly expand and shrink in volume during battery cycling.

The high-elasticity polymer forms a continuous material phase that substantially embraces the anode material particles and the conductive additive (e.g., CNTs, graphene sheets, carbon black particles, etc.). Being a continuous phase that is ion-conducting, the integrated elastomer/plastic crystal or elastomer/plasticizer material provides robust lithium ion-conducting pathways. The amount of conductive additive is preferably sufficient to form a 3D network of electron-conducing pathways that are in electrical contact with the anode material particles. Such an elastomeric or rubbery matrix also acts to maintain the structural integrity of the anode electrode, preventing interruption of the electron- and lithium ion-conducting pathways when the anode active material particles repeatedly expand and shrink in volume during battery cycling.

The high-elasticity polymer preferably has a recoverable tensile strain typically from 5% to 700% and more typically from 10% to 300%, when measured without an additive or reinforcement. The polymer (elastomer or rubber) preferably has a lithium ion conductivity no less than 10⁻⁶ S/cm (preferably >10⁻⁵ S/cm, further preferably >10-4 S/cm, and more preferably >10⁻³ S/cm) when measured at room temperature.

The elastomer or rubber may be selected from natural polyisoprene, synthetic polyisoprene, polybutadiene, chloroprene rubber, polychloroprene, butyl rubber, butyl acrylic rubber, styrene-butadiene rubber, nitrile rubber, ethylene propylene rubber, ethylene propylene diene rubber, epichlorohydrin rubber, polyacrylic rubber, silicone rubber or polysiloxane, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyurethane, urethane-urea copolymer, poly(phosphazene), a copolymer thereof, a chemically substituted version thereof, a chemical derivative thereof, a sulfonated version thereof, or a combination thereof.

In some embodiments, the elastomer or rubber is selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, copolymers thereof, chemical derivatives thereof, and combinations thereof.

Polyurethane and its copolymers (e.g., urea-urethane copolymer) or chemically modified versions are particularly useful elastomeric matrix materials for protecting anode active material particles. The urethane-urea copolymer usually consists of two types of domains, soft domains and hard domains. Entangled linear backbone chains consisting of poly(tetramethylene ether) glycol (PTMEG) units constitute the soft domains, while repeated methylene diphenyl diisocyanate (MDI) and ethylene diamine (EDA) units constitute the hard domains. The lithium ion-conducting additive can be incorporated in the soft domains or other more amorphous zones.

Unsaturated rubbers that can be vulcanized to become elastomer include natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), Some elastomers are saturated rubbers that cannot be cured by sulfur vulcanization; they are made into a rubbery or elastomeric material via different means: e.g., by having a copolymer domain that holds other linear chains together. Each of these elastomers can be used as a matrix.

In the structure of a resin matrix, the elastomer or rubber, along with the plastic crystal or plasticizer domains dispersed therein (or constituting co-continuous phases), forms a continuous material phase. This continuous phase makes physical and ionic contact with all the anode active material particles dispersed in this continuous phase (matrix). Even when the anode active material particles (e.g., Si) expand in volume or even get pulverized, the particles or the resulting fragments remain in contact with this ion-conducting matrix. This is key to charge/discharge cycling stability of the lithium-ion cell.

In some embodiments, the high-elasticity polymer further comprises a plasticizer or diluent dispersed therein, wherein the plasticizer or diluent is selected from the group consisting of bis(2-methoxyethyl) ether, sulfones, sulfides, nitrile (e.g., dinitriles), acrylonitrile (AN), succino-nitrile, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

Plasticizers for rubber may be selected from nontoxic aromatic oils, such as distillate aromatic extract (DAE), treated distillate aromatic extract (TDAE), and mild extraction solvates (MESs), residual aromatic extract (RAE), hydrogenated naphthenic oils (HNAP), and naphthenic oils, paraffinic oils. However, it would be advantageous to select those oils that have a higher dielectric constant.

In certain desired embodiments, the high-elasticity polymer in the separator comprises from 5% to 95% by weight (preferably from 25% to 75%, more preferably from 35% to 65%, and most preferably from 45% to 55%) of a lithium ion-conducting plastic crystal or organic domain phase dispersed in or connected to the high-elasticity polymer. Preferably, the high-elasticity polymer and the plastic crystal phase or organic domain form co-continuous phases exhibiting a lithium-ion conductivity no less than 10⁻⁵ S/cm. These high-elasticity polymers elastomers can be used for lithium metal batteries, lithium air batteries, lithium-sulfur batteries, and lithium-selenium batteries.

The plastic crystal or organic domain phase typically and desirably comprises a mixture of a lithium salt and a lithium ion conducting organic species. These organic species preferably have a relatively high dielectric constant (preferably >5, more preferably >20, and further preferably >50) that is conducive to dissolving a suitable amount of a lithium salt. The mixture must also have chemical compatibility with the crosslinked network of chains of the elastic polymer and can be readily impregnate into the nano-scaled spaces between these chains. The organic species may be in the form of an oligomer or low molecular weight polymer having a number average molecular weight preferably less than 10,000 g/mole.

The desirable organic species in the plastic crystal/organic domain phase may be selected from a fluorinated carbonate, hydrofluoroether, fluorinated vinyl carbonate, fluorinated ester, fluorinated vinyl ester, fluorinated vinyl ether, sulfone, sulfide, nitrile (dinitrile), succino-nitrile, acrylonitrile, sulfate, siloxane, silane, phosphate, phosphonate, phosphinate, phosphine, phosphine oxide, phosphonic acid, phosphorous acid, phosphite, phosphoric acid, phosphazene compound, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfolane, acetonitrile, acrylonitrile, fluoroethylene carbonate (FEC), an ionic liquid solvent, a polymerized version thereof, or a combination thereof. The polymerized versions of these polymers preferably have a low molecular weight, having a number average molecular weight preferably less than 10,000 g/mole (more preferably <5,000 g/mole and further more preferably <2,000 g/mole).

The sulfone or sulfide is selected from vinyl sulfone, allyl sulfone, alkyl vinyl sulfone, aryl vinyl sulfone, vinyl sulfide, a vinyl-containing variant of TrMS, MTrMS, TMS, EMS, MMES, EMES, EMEES, or a combination thereof:

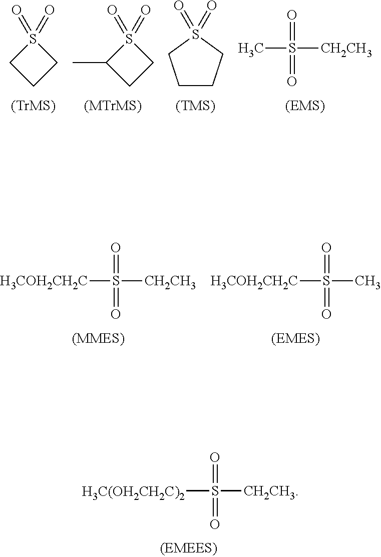

The vinyl sulfone or sulfide may be selected from ethyl vinyl sulfide, allyl methyl sulfide, phenyl vinyl sulfide, phenyl vinyl sulfoxide, allyl phenyl sulfone, allyl methyl sulfone, divinyl sulfone, or a combination thereof, wherein the vinyl sulfone does not include methyl ethylene sulfone and ethyl vinyl sulfone.

The nitrile preferably comprises a dinitrile or is selected from AND, GLN, SEN, succino-nitrile (SN), or a combination thereof:

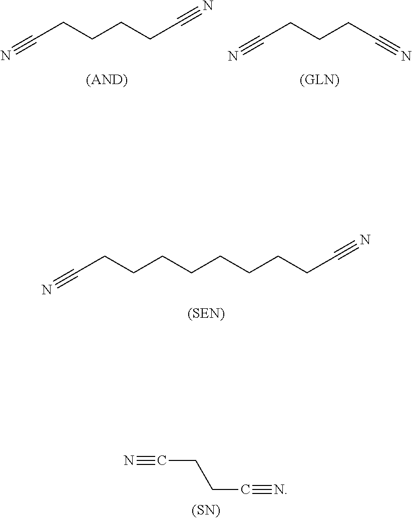

The phosphate may be selected from allyl-type, vinyl-type, styrenic-type and (meth)acrylic-type monomers bearing a phosphonate moiety. The phosphate, phosphonate, phosphonic acid, phosphazene, or phosphite may be selected from TMP, TEP, TFP, TDP, DPOF, DMMP, DMMEMP, tris(trimethylsilyl)phosphite (TTSPi), alkyl phosphate, triallyl phosphate (TAP), a combination thereof, wherein TMP, TEP, TFP, TDP, DPOF DMMP, DMMEMP, and phosphazenhe have the following chemical formulae:

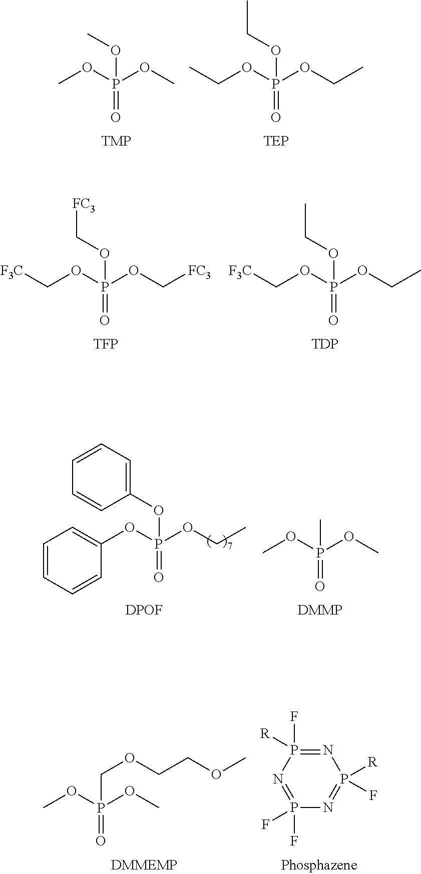

wherein R═H, NH₂, or C₁-C₆ alkyl.
   The siloxane or silane may be selected from alkylsiloxane (Si—O), alkyylsilane (Si—C), liquid oligomeric silaxane (—Si—O—Si—), or a combination thereof.

The crosslinking agent may be selected from methyl benzoylformate, N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), citric acid, acrylic acid, methacrylic acid, a derivative compound of acrylic acid, a derivative compound of methacrylic acid (e.g. polyhydroxyethylmethacrylate), glycidyl functions, N,N′-Methylenebisacrylamide (MBAAm), Ethylene glycol dimethacrylate (EGDMAAm), isobornyl methacrylate, poly (acrylic acid) (PAA; Formula 3a and Formula 3b), methyl methacrylate, isobornyl acrylate, ethyl methacrylate, isobutyl methacrylate, n-Butyl methacrylate, ethyl acrylate, 2-Ethyl hexyl acrylate, n-Butyl acrylate, a diisocyanate (e.g. methylene diphenyl diisocyanate, MDI), an urethane chain, a chemical derivative thereof, or a combination thereof.

High-elasticity polymer refers to an elastomer or rubber, typically a lightly cross-linked polymer, which exhibits an elastic deformation that is at least 5% when measured (without an additive or reinforcement in the polymer) under uniaxial tension. In the field of materials science and engineering, the “elastic deformation” is defined as a deformation of a material (when being mechanically stressed) that is essentially fully recoverable and the recovery is essentially instantaneous upon release of the load. The elastic deformation is preferably greater than 30%, more preferably greater than 50%, further more preferably greater than 100%, still more preferably greater than 150%, and most preferably greater than 200%. Certain elastomers are not chemically cross-linked, but still exhibit good elasticity; examples being polysiloxane derivatives and certain thermoplastic elastomers.

The high-elasticity elastic polymer may further comprise from 0.1% to 80% by weight of a lithium ion-conducting material dispersed or dissolved in the high-elasticity polymer. The lithium ion-conducting material may comprise a lithium salt selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

In some embodiments, the lithium ion-conducting material is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

In certain embodiments, the high-elasticity polymer forms a mixture, blend, copolymer, crosslinked network, or interpenetrating network with a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

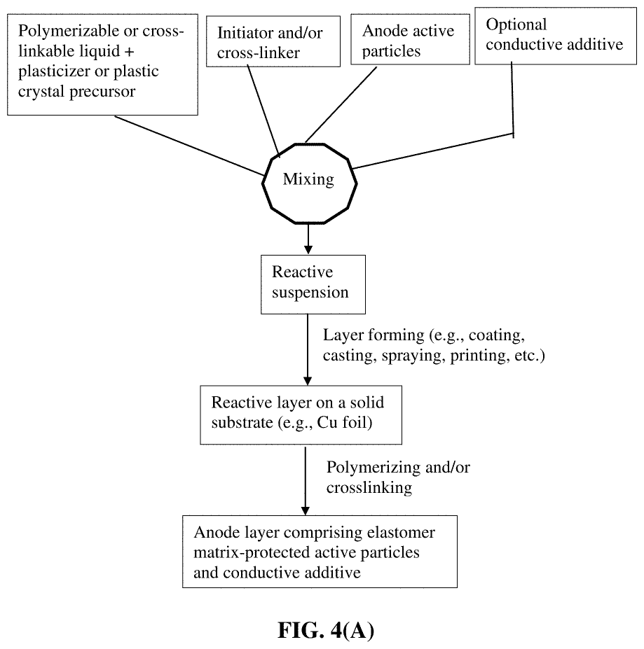

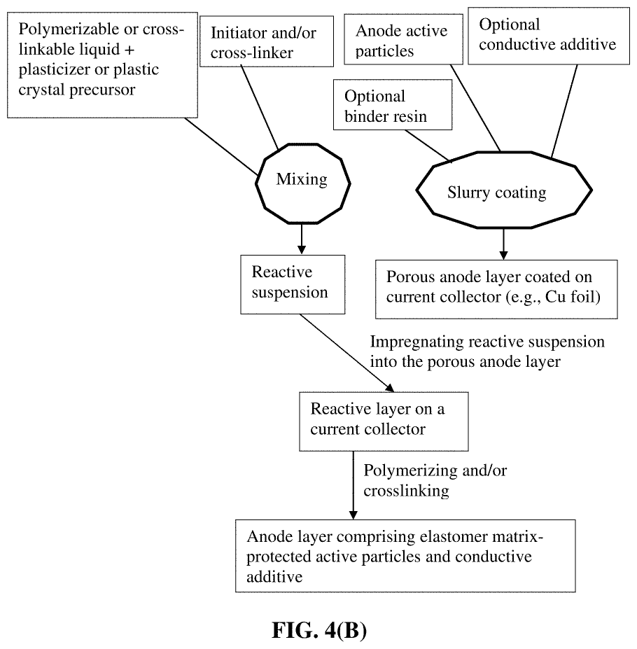

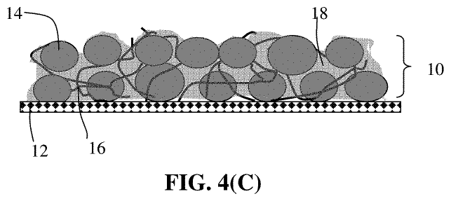

As illustrated in FIG. 4(C), the present disclosure provides an anode active material layer 10 bonded on a surface of an anode current collector (e.g., a Cu foil, 12). The anode layer comprises multiple primary particles 14 of an anode active material (e.g., particles of Si, Ge, P, SiO, Sn, SnO₂, etc.) and a conductive additive 16 (e.g., CNTs, graphene sheets, expanded graphite flakes, carbon black particles, etc.). Both the anode particles and the conductive additive are substantially embedded in an elastomer or rubber matrix 18, which contains an ion-conducting phase (plastic crystal or plasticizer domains) dispersed therein.

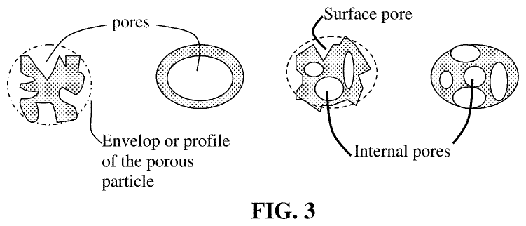

The primary particles themselves may be porous having porosity in the form of surface pores and/or internal pores. FIG. 3 shows some examples of porous primary particles of an anode active material. The anode electrode may also be designed to contain a desired amount of pores, preferably 10%-70% by volume, more preferably 20-50% by volume and most preferably 30-40% by volume. These pores of the primary particles and pores of the anode electrode combined allow the particle to expand into the free space without a significant overall volume increase of the particles and without inducing any significant volume expansion of the entire anode electrode.

This amount of pore volume provides empty space to accommodate the volume expansion of the anode active material so that the polymer matrix would not have to significantly expand (e.g., not to induce a 20% volume expansion of the anode active layer) when the lithium battery is charged. Preferably, the anode active layer does not increase its volume by more than 10%. We have discovered that this strategy surprisingly results in significantly reduced battery capacity decay rate and dramatically increased charge/discharge cycle numbers. These results are highly significant with great utility value.

Multiple non-lithiated Si particles, along with particles or nano-tubes of a conductive additive, can be dispersed or embedded in a high-elasticity polymer (elastomer or rubber plus an ion-conducting phase). As the lithium-ion battery is charged, the anode active material particles (e.g., Si) are intercalated with lithium ions and, hence, the Si particle expands. Due to the high elasticity of the polymer, the polymer may simply expand accordingly without breaking up into pieces. That the high-elasticity polymer remains intact prevents the exposure of the embedded Si particles to liquid electrolyte and, thus, prevents the Si from undergoing undesirable reactions with electrolyte during repeated charges/discharges of the battery. This strategy prevents continued consumption of the electrolyte and lithium ions to form additional SEI. Furthermore, this elastic resin matrix is also capable of maintaining structural integrity of the anode electrode and, hence, the integrity of the electron- and lithium ion-conducting pathways. Disintegration of an anode electrode is otherwise another major cause for rapid capacity decay of a Si-rich anode-based lithium-ion battery.

The anode electrode may contain a conductive additive selected from a graphite, graphene, and/or carbon material dispersed in the high-elasticity polymer matrix. The carbon or graphite material may be selected from polymeric carbon, amorphous carbon, chemical vapor deposition carbon, coal tar pitch, petroleum pitch, meso-phase pitch, carbon black, coke, acetylene black, activated carbon, fine expanded graphite particle with a dimension smaller than 100 nm, artificial graphite particle, natural graphite particle, carbon nano-tubes (single-walled or multi-walled), carbon nano-fibers (vapor-grown or carbonized polymer fibers), graphitic nano-fibers, graphene sheets, or a combination thereof. Graphene may be selected from pristine graphene, graphene oxide, reduced graphene oxide, graphene fluoride, hydrogenated graphene, nitrogenated graphene, functionalized graphene, etc.

The carbon/graphite/graphene particles, fibers, nanotubes, and/or nano sheets are dispersed in the high-elasticity resin matrix and constitute a 3D network of electron-conducting paths that preferably are in contact with individual primary particles of the anode active material. The high-elasticity polymer matrix, being a continuous phase and making contact with individual primary particles (being substantially totally immersed in the polymer matrix) provide a 3D network of lithium ion-conducting paths. In other words, there are dual networks of conducting pathways for electrons and lithium ions inside the anode electrode.

The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles; (g) prelithiated versions thereof; (h) lithium metal or alloy particles; and (i) combinations thereof.

Pre-lithiation of an anode active material can be conducted by several methods (chemical intercalation, ion implementation, and electrochemical intercalation). Among these, the electrochemical intercalation is the most effective. Lithium ions can be intercalated into non-Li elements (e.g. Si, Ge, and Sn) and compounds (e.g. SnO₂ and Co₃O₄) up to a weight percentage of 54.68% (see Table 1 below). For Zn, Mg, Ag, and Au encapsulated inside an elastomer shell, the amount of Li can reach 99% by weight.

TABLE 1
Lithium storage capacity of selected non-Li elements.

| Intercalated | Atomic weight | Atomic weight of | Max. wt. % |
|---|---|---|---|
| compound | of Li, g/mole | active material, g/mole | of Li |
| Li₄Si | 6.941 | 28.086 | 49.71 |
| Li_{4.4}Si | 6.941 | 28.086 | 54.68 |
| Li_{4.4}Ge | 6.941 | 72.61 | 30.43 |
| Li_{4.4}Sn | 6.941 | 118.71 | 20.85 |
| Li₃Cd | 6.941 | 112.411 | 14.86 |
| Li₃Sb | 6.941 | 121.76 | 13.93 |
| Li_{4.4}Pb | 6.941 | 207.2 | 13.00 |
| LiZn | 6.941 | 65.39 | 7.45 |
| Li₃Bi | 6.941 | 208.98 | 8.80 |

The particles of the anode active material may be in the form of a nano particle, nano wire, nano fiber, nano tube, nano sheet, nano platelet, nano disc, nano belt, nano ribbon, or nano horn. They can be non-lithiated (when incorporated into the anode active material layer) or pre-lithiated to a desired extent (up to the maximum capacity as allowed for a specific element or compound.

Preferably and typically, the high-elasticity polymer has a lithium ion conductivity no less than 10⁻⁵ S/cm, more preferably no less than 10⁻⁴ S/cm, further preferably no less than 10⁻³ S/cm, and most preferably no less than 10⁻² S/cm. In some embodiments, the high-elasticity polymer is a polymer having a phase of plastic crystal or plasticizer domains dispersed therein. In others, the high-elasticity polymer is a polymer matrix composite containing from 0.1% to 50% (preferably 1% to 35%) by weight of a lithium ion-conducting additive dispersed in the high-elasticity polymer matrix material. The high-elasticity polymer must have a high elasticity (elastic deformation strain value>5%).

An elastic deformation is a deformation that is fully recoverable and the recovery process is essentially instantaneous (no significant time delay) upon release of the mechanical stress. The high-elasticity polymer can exhibit an elastic deformation from 5% up to 1,000% (10 times of its original length), more typically from 10% to 800%, and further more typically from 50% to 500%, and most typically and desirably from 70% to 300%.

It may be noted that although a metal typically has a high ductility (i.e. can be extended to a large extent without breakage), the majority of the deformation is plastic deformation (non-recoverable) and only a small amount of elastic deformation (typically <1% and more typically <0.2%).

There are at least two ways or approaches with which an anode electrode featuring elastic polymer-protected anode particles can be made, briefly described below:

As illustrated in FIG. 4(B), the first approach includes mixing primary particles of an anode active material, a conductive additive (e.g., carbon black particles, CNTs, graphene sheets, etc.), and a resin binder in a liquid medium (e.g., water or organic solvent such as NMP, acetone, and THF) to form a slurry. The slurry is then coated onto a surface or two surfaces of an anode current collector (e.g., Cu foil) and dried to form an anode electrode that contains pores in the anode layer(s).

A polymerizable liquid, comprising (i) a monomer and an initiator or (ii) a cross-linkable polymer or oligomer solution comprising a curing agent (along with a plasticizer or plastic crystal precursor), is then allowed to impregnate into the pores of an anode layer. This is followed by polymerization or cross-linking to form the desired polymer chains that embrace the anode active primary particles and the conductive additive in the anode electrode.

Alternatively, one may choose to dissolve a thermoplastic elastomer in a liquid solvent to form a solution, which is also added with a plasticizer or plastic crystal precursor. This is followed by impregnating the solution into pores of the anode layer. Subsequently, the liquid solvent is removed, allowing the thermoplastic elastomer to precipitate out to engulf around anode active particles and the conductive additive particles.

The second approach, illustrated in FIG. 4(A), comprises mixing (i) a monomer, oligomer, or cross-linkable linear or branched chain in a solution or liquid state (along with plasticizer or plastic crystal precursor), (ii) an initiator and/or curing agent, (iii) primary particles of an anode active material (e.g., Si, SnO₂ nano particles, etc.), and (iv) a conductive additive to form a slurry. The slurry is then coated onto a primary surface or two surfaces of an anode current collector (e.g., stainless steel or Ni foil), followed by polymerization and/or curing to form an anode electrode that features the desired elastic polymer-protected anode active material particles. The elastic polymer plays the dual functions of acting as a resin binder and as a protecting matrix or encapsulating material.

It is essential for these materials (monomers, oligomers, or cross-linkable polymers) to form a lightly cross-linked network of polymer chains. In other words, the network polymer or cross-linked polymer should have a relatively low degree of cross-linking or low cross-link density to impart a high elastic deformation.

The cross-link density of a cross-linked network of polymer chains may be defined as the inverse of the molecular weight between cross-links (Mc). The cross-link density can be determined by the equation, Mc=ρRT/Ge, where Ge is the equilibrium modulus as determined by a temperature sweep in dynamic mechanical analysis, ρ is the physical density, R is the universal gas constant in J/mol*K and T is absolute temperature in K. Once Ge and p are determined experimentally, then Mc and the cross-link density can be calculated.

The magnitude of Mc may be normalized by dividing the Mc value by the molecular weight of the characteristic repeat unit in the cross-link chain or chain linkage to obtain a number, Nc, which is the number of repeating units between two cross-link points. We have found that the elastic deformation strain correlates very well with Me and Nc. The elasticity of a cross-linked polymer derives from a large number of repeating units (large Nc) between cross-links. The repeating units can assume a more relax conformation (e.g., random coil) when the polymer is not stressed. However, when the polymer is mechanically stressed, the linkage chain uncoils or gets stretched to provide a large deformation. A long chain linkage between cross-link points (larger Nc) enables a larger elastic deformation. Upon release of the load, the linkage chain returns to the more relaxed or coiled state. During mechanical loading of a polymer, the cross-links prevent slippage of chains that otherwise form plastic deformation (non-recoverable).

Preferably, the Nc value in a high-elasticity polymer is greater than 5, more preferably greater than 10, further more preferably greater than 100, and even more preferably greater than 200. These Nc values can be readily controlled and varied to achieve different elastic deformation values by using different cross-linking agents with different functionalities, and by designing the polymerization and cross-linking reactions to proceed at different temperatures for different periods of time.

Alternatively, Mooney-Rilvin method may be used to determine the degree of cross-linking. Crosslinking also can be measured by swelling experiments. In a swelling experiment, the crosslinked sample is placed into a good solvent for the corresponding linear polymer at a specific temperature, and either the change in mass or the change in volume is measured. The higher the degree of crosslinking, the less swelling is attainable. Based on the degree of swelling, the Flory Interaction Parameter (which relates the solvent interaction with the sample, Flory Huggins Eq.), and the density of the solvent, the theoretical degree of crosslinking can be calculated according to Flory's Network Theory. The Flory-Rehner Equation can be useful in the determination of cross-linking.

The high-elasticity polymer matrix may contain a simultaneous interpenetrating network (SIPN) polymer, wherein two cross-linking chains intertwine with each other, or a semi-interpenetrating network polymer (semi-IPN), which contains a cross-linked polymer and a linear polymer.

The aforementioned high-elasticity polymers may be used alone to serve as a matrix. Alternatively, the high-elasticity polymer can be mixed with a broad array of electrically conducting polymers, lithium ion-conducting materials, and/or strengthening materials (e.g. carbon nanotube, carbon nano-fiber, or graphene sheets).

Typically, an elastomer is originally in a monomer or oligomer states that can be cured to form a cross-linked polymer that is highly elastic. Prior to curing, these polymers or oligomers are soluble in an organic solvent to form a polymer solution. An ion-conducting or electron-conducting additive may be added to this solution to form a suspension. This solution or suspension can then be formed into a thin layer of polymer precursor on a surface of a porous anode electrode. The polymer precursor (monomer or oligomer and initiator) and the plasticizer or plastic crystal precursor (organic species), after permeating into pores of the anode electrode, is then polymerized and cured to form a lightly cross-linked polymer. Polymer precursor deposition (prior to solution impregnation) can be accomplished by using one of several procedures well-known in the art; e.g., spraying, spray-painting, printing, coating, extrusion-based film-forming, casting, etc.

One may dispense and deposit a layer of liquid solution comprising a sulfonated or unsulfonated elastomer onto a primary surface of the anode active material layer. Sulfonation of an elastomer or rubber may be accomplished by exposing the elastomer/rubber to a sulfonation agent in a solution state or melt state, in a batch manner or in a continuous process. The sulfonating agent may be selected from sulfuric acid, sulfonic acid, sulfur trioxide, chlorosulfonic acid, a bisulfate, a sulfate (e.g., zinc sulfate, acetyl sulfate, etc.), a mixture thereof, or a mixture thereof with another chemical species (e.g., acetic anhydride, thiolacetic acid, or other types of acids, etc.). In addition to zinc sulfate, there are a wide variety of metal sulfates that may be used as a sulfonating agent; e.g. those sulfates containing Mg, Ca, Co, Li, Ba, Na, Pb, Ni, Fe, Mn, K, Hg, Cr, and other transition metals, etc.

For instance, a triblock copolymer, poly(styrene-isobutylene-styrene) or SIBS, may be sulfonated to several different levels ranging from 0.36 to 2.04 mequiv./g (13 to 82 mol % of styrene; styrene being 19 mol % of the unsulfonated block copolymer). Sulfonation of SIBS may be performed in solution with acetyl sulfate as the sulfonating agent. First, acetic anhydride reacts with sulfuric acid to form acetyl sulfate (a sulfonating agent) and acetic acid (a by-product). Then, excess water is removed since anhydrous conditions are required for sulfonation of SIBS. The SIBS is then mixed with the mixture of acetyl sulfate and acetic acid. Such a sulfonation reaction produces sulfonic acid substituted to the para-position of the aromatic ring in the styrene block of the polymer. Elastomers having an aromatic ring may be sulfonated in a similar manner.

A sulfonated elastomer also may be synthesized by copolymerization of a low level of functionalized (i.e., sulfonated) monomer with an unsaturated monomer (e.g., olefinic monomer, isoprene monomer or oligomer, butadiene monomer or oligomer, etc.).

A broad array of elastomers can be sulfonated to become sulfonated elastomers. The elastomeric material may be selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

The following examples serve to provide the best modes of practice for the present disclosure and should not be construed as limiting the scope of the disclosure:

### Example 1: Si-Based Anode Layer Featuring a High-Elasticity Comprising poly(butyl acrylate) Rubber Containing Dinitrile/LiTFSI-Based Plastic Crystals Dispersed Therein

For polymerization of PBA rubber, azobisisobutyronitrile (AIBN; 0.5 mol %) and poly(ethylene glycol) diacrylate (PEGDA; 1 mol %) were used as the thermal initiator and cross-linking agent, respectively. In this butyl acrylate (BA) polymerization process, BA/PEGDA produces polymers chemically cross-linked by PEGDA, eventually resulting in elastomer networks. Dinitrile (AND, GLN, and SEN, respectively), in combination with a lithium salt (e.g., LiTFSI), were used to form plastic crystal domains, where the chemical structures of these dinitriles are given below:

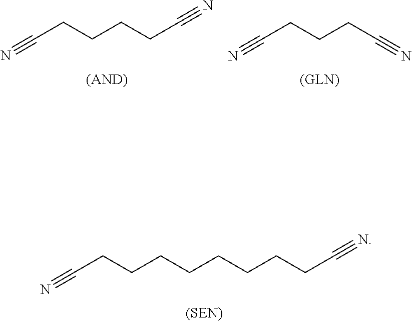 [SMILES: N#CCCCCC#N ; N#CCCCC#N ; N#CCCCCCCCCC#N]

The BA-based solutions were prepared by dissolving 1 mol % PEGDA, 0.5 mol % AIBN, and 1 M LiTFSI powder in BA liquid. The BA-based solutions were polymerized at 70° C. for 2 h to obtain BA-based elastomer with plastic crystal domains dispersed therein. The dinitrile-based solutions were made by mixing a dinitrile with 1 M LiTFSI powder and 5 vol % fluoroethylene carbonate additive at 60° C. to protect against the potential side reaction of dinitrile with Li metal. The two prepared liquid solutions were homogeneously mixed in a volume ratio of 1:1 at 50° C. to produce the elastomer.

A porous anode layer was prepared by mixing graphene-encapsulated Si particles (Honeycomb Battery Co., Dayton, Ohio), 7% by weight of acetylene black as a conductive additive, and 5% CMC as a binder into water to form a slurry. The slurry was then coated onto a Cu foil and dried to form the anode electrode.

After dispensing and depositing the prepared solution onto a surface of the anode active material layer and giving a sufficient length of time for the solution to permeate into pores of the anode, the reactive mass was heated at 70° C. for 2 h to obtain the elastomer. For the preparation of a lithium-ion cell, the anode electrode, a polymer membrane separator, and a cathode electrode were assembled into a cell. In this study, the cathode active layers were prepared from NCM-811 and LFP as cathode active materials, respectively.

### Example 2: Poly(butyl acrylate) Rubber Containing Combined lithium bis(oxalato)borate (LiBOB)/DMMP, DMMEMP, and phosphazene-Based Ion-Conducting Domains

Substantially the same procedure as described in Example 1 was followed, but using lithium bis(oxalato)borate (LiBOB)/DMMP, DMMEMP, and phosphazene as the lithium ion-conducting organic species:

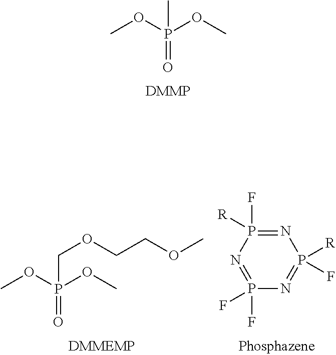

wherein R═H. The lithium ion conductivity of this group of elastic polymer separator layers was found to be from 0.24×10⁻³ to 1.6×10⁻³ S/cm.

### Example 3: Anode Layer Comprising Cobalt Oxide (Co₃O₄) Particles Embedded in a High-Elasticity Polymer Matrix Containing an Elastomer and a Plasticizer

An appropriate amount of inorganic salts Co(NO₃)₂·6H₂O and ammonia solution (NH₃·H₂O, 25 wt. %) were mixed together. The resulting suspension was stirred for several hours under an argon flow to ensure a complete reaction. The obtained Co(OH)₂ precursor suspension was calcined at 450° C. in air for 2 h to form particles of the layered Co₃O₄. Portion of the Co₃O₄ particles was then encapsulated with a urea-urethane copolymer with the encapsulating elastomer shell thickness being varied from 17 nm to 135 nm.

For electrochemical testing, the working electrodes were prepared by mixing 85 wt. % active material (Co₃O₄ particles), 7 wt. % acetylene black (Super-P), and 8 wt. % polyvinylidene fluoride (PVDF) binder dissolved in N-methyl-2-pyrrolidinoe (NMP) to form a slurry of 5 wt. % total solid content. After coating the slurries on Cu foil, the electrodes were dried at 120° C. in vacuum for 2 h to remove the solvent, forming a porous anode layer bonded to a Cu foil surface.

Solution-based styrene-rubber (SBR) was produced by a well-known anionic polymerization process. Polymerization was initiated by alkyl lithium compound. The process was homogeneous having all components being fully dissolved in a solvent. In one example, styrene and 1,3-butadiene solutions were made up at 14 to 15 weight percent in hexanes (mixed hexane isomers) with 1,2-butadiene added for gel suppression at a level of 100-150 ppm (based on total monomer). The monomer solutions were purified by passing over molecular sieves and silica gel. The reactive solution was then poured over the porous anode electrode, allowing the reactive solution to permeate into pores of the anode and engulf or surround substantially all the anode active material particles. During polymerization, the organolithium compound adds to one of the monomers, generating a carbonion that then adds to another monomer, and so on. The polymerization was terminated by adding a desired amount of sulfone (TMS or EMS), which also serves as a plastic crystal phase in the elastomer:

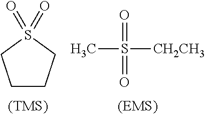

Then, the electrodes were cut into a disk (ϕ=12 mm) and dried at 100° C. for 24 h in vacuum. Electrochemical measurements were carried out using CR2032 (3V) coin-type cells with lithium metal as the counter/reference electrode, Celgard 2400 membrane as separator, and 1 M LiPF₆ electrolyte solution dissolved in a mixture of ethylene carbonate (EC) and diethyl carbonate (DEC) (EC-DEC, 1:1 v/v). The cell assembly was performed in an argon-filled glove-box. The CV measurements were carried out using a CH-6 electrochemical workstation at a scanning rate of 1 mV/s.

The electrochemical performance of the elastomer-protected Co₃O₄-based anode and that of non-protected anode were evaluated by galvanostatic charge/discharge cycling at a current density of 50 mA/g, using a LAND electrochemical workstation. The results indicate that the charge/discharge profiles for the protected and un-protected Co₃O₄ anode electrodes show a long voltage plateau at about 1.06 V and 1.10 V, respectively, followed by a slopping curve down to the cut-off voltage of 0.01 V, indicative of typical characteristics of voltage trends for the Co₃O₄ electrode.

### Example 4: Polyurethane Copolymer-Protected Micron-Scale Si Particles and SiO Particles

Polyurethane (PU)-g-poly(ethylene glycol) (PEG) copolymers were synthesized as an elastic resin matrix for protecting Si particles. A macroiniferter consisting of polyurethane (PU) with tetraphenylethane groups was synthesized by the reaction of 1,1,2,2-tetraphenyl-1,2-ethanediol and isocyanate-terminated prepolymer with poly(tetramethylene glycol) (PTMG) segments. Such a macroiniferter initiates the polymerization of poly(ethylene glycol) methyl ether methacrylate to yield the target copolymer.

The chemicals used in this example include Poly(tetramethylene glycol) (PTMG) (Mw=2000 g/mol) (PTMG2000), 1,1,2,2-tetraphenyl-1,2-ethanediol (TPE), Methoxy polyethylene glycol (Mw=2000 g/mol) (MPEG2000), 4,4′-Diphenylmethane diisocyanate (MDI), dibutyltindilaurate (DBTDL), methacryloyl chloride, Triethylamine, Tetrahydrofuran (THF), methylene chloride (CH₂Cl₂), and N,N′-dimethylformamide (DMF). The synthesis of the PU-g-PEG copolymers is illustrated in Scheme 1 below:

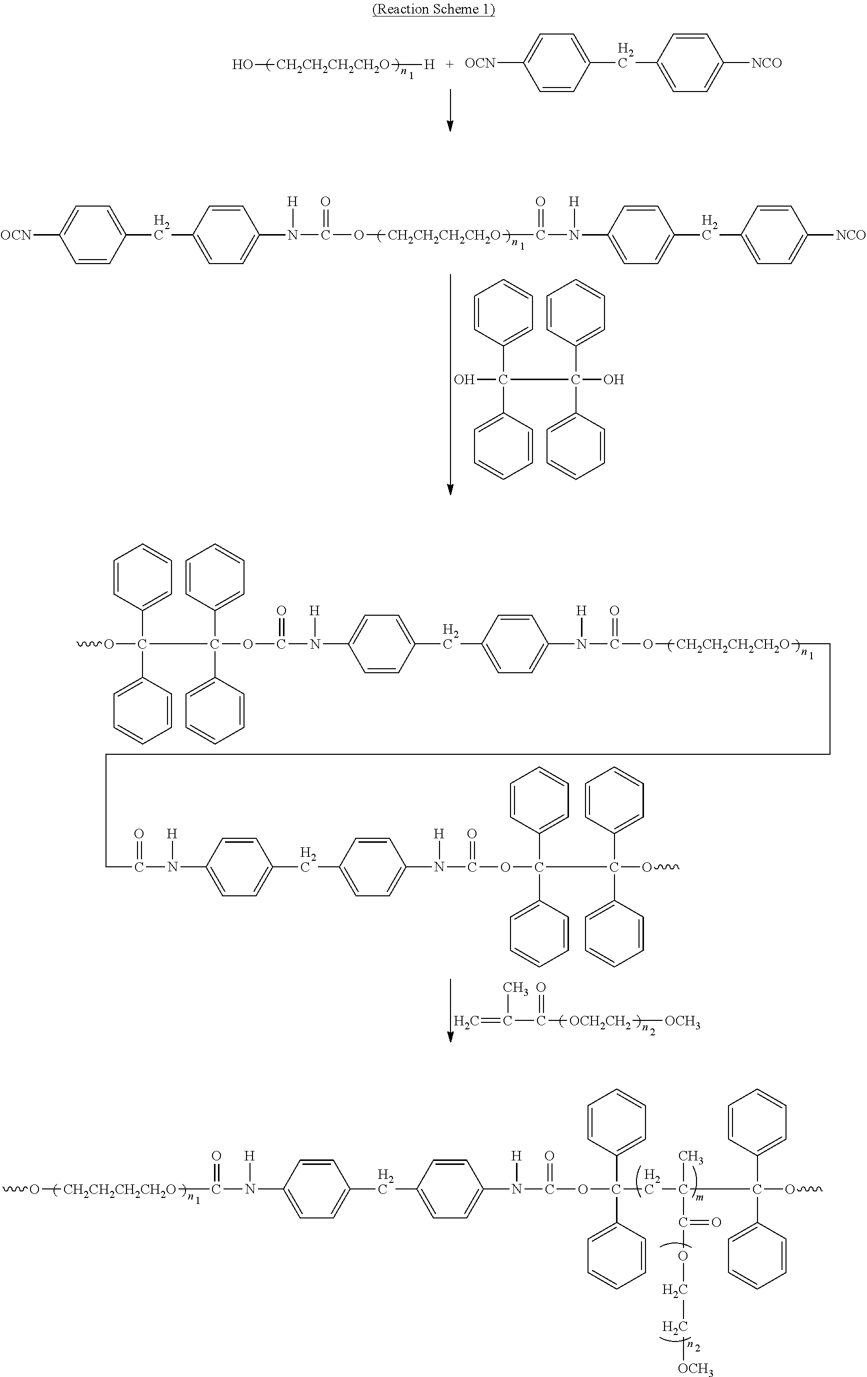

Step 1 involves the synthesis of PU macroiniferter. As shown in Scheme 1, isocyanate end capped prepolymer was synthesized via reaction of PTMG2000 with MDI, which further reacted with TPE as chain extender to yield the PU macroiniferter (PUI). Specifically, PTMG2000 (30 g, 0.015 mol) and MDI (7.56 g, 0.03 mol) were added into a 500 mL flask and stirred at 60° C. under nitrogen atmosphere. When diisocyanate content decreased to the half of the initial value, the reaction mixture was cooled to 30° C. Subsequently, TPE (5.55 g, 0.015 mol) and DBTDL (0.1 wt % based on the initial isocyanate content) were added and reacted for 24 h at 30° C. At the end of the reaction, 5.0 mL of methanol was added and stirred for another 15 min. The product was precipitated in methanol-water mixture (v/v: 2/1), filtered, washed thoroughly with methanol to remove the unreacted TPE and dried in vacuum.

Step 2 involves the synthesis of poly(ethylene glycol) methyl ether methacrylate (PEGMA). PEGMA was synthesized according to the following procedure: Typically, MPEG2000 (40 g, 0.02 mol), CH₂Cl₂ (200 ml) and triethylamine (23.1 mL, 0.16 mol) were added into a 250 mL three-neck flask equipped with a magnetic stirrer. Methacryloyl chloride (15.4 mL, 0.16 mol) was slowly dropped into the mixture at 0° C. The mixture was further stirred at room temperature for 24 h. Then, 6.0 mL methanol was slowly added at 0° C. to react with the excess of methacryloyl chloride. The reaction solution was filtered and passed through an alkaline alumina column to remove the triethylammonium chloride. The product was precipitated into cold diethyl ether, filtered and dried under vacuum.

Step 3 involves synthesis of PU-g-PEG copolymers. A desired amount of PUI, PEGMA, and DMF were added into a Pyrex vial. After three freeze-pump-thaw cycles, the vial was sealed under vacuum and then reacted at 80° C. for 24 h. The reaction was arrested by dipping in liquid N₂.

A controlled amount of the unreacted PEGMA monomer was retained in the PU-g-PEG copolymer as a plasticizer phase. The copolymer is designed as PU-g-PEGx, where x is the weight percentage of PEG determined by 1H NMR. The DMF solution containing PU-g-PEGx copolymer and PEGMA was sprayed over a porous anode electrode, enabling the solution to permeate into pores of the anode electrode. (A conventional slurry coating process was adapted to form this porous anode electrode on a Cu foil surface. The anode was composed of Si or SiO nano particles, along with 2% CNTs as a conductive additive, and 5% CMC as a resin binder.) The liquid solvent was then removed to obtain the desired PU-g-PEGx copolymer/PEGMA-protected anode.

### Example 5: Hyperbranched Polyurethanes Copolymer Matrix-Protected Anode

In this study, hyperbranched polyurethanes were prepared by using the oligomeric A₂+B₃ approach. The synthesis of hyperbranched polymers was carried out by reaction of trimethylolpropane (TMP) with poly(ethylene glycol) (PEG)-terminated isophorone diisocyanate (IPDI). In this approach, hyperbranched polyurethanes with isocyanate-terminated prepolymer (A2) and core molecule, trimethylolpropane (B3), were synthesized by conducting the reactions under nitrogen atmosphere. In the first stage, dried PEG (0.001 mol) was allowed to melt and then, IPDI (0.00205 mol) was added in slight excess (molar ratio=1:2.05). The reaction was carried out for 3 h at 70° C. in the presence of a catalyst, dibutyltindilaurate (DBTDL, 2 drops), and solvent MEK (60 mL), resulting in the formation of an isocyanate-terminated adduct. After formation of urethane linked adduct, trimethylolpropane was added to the reaction mixture in the second stage. Organic plasticizer, 1,3-dioxolane (DOL) and 1,2-dimethoxyethane (DME), along with a lithium salt (LiTFSI) were added into the reacting mass after initial reactions for 2 hours. In one example, the reaction mixture was allowed to permeate into pores of a pre-made porous anode electrode layer. The reaction was continued for another 14 h to form the hyperbranched polymer as shown in Reaction Scheme 2 below. The liquid solvent was then removed in a vacuum oven.

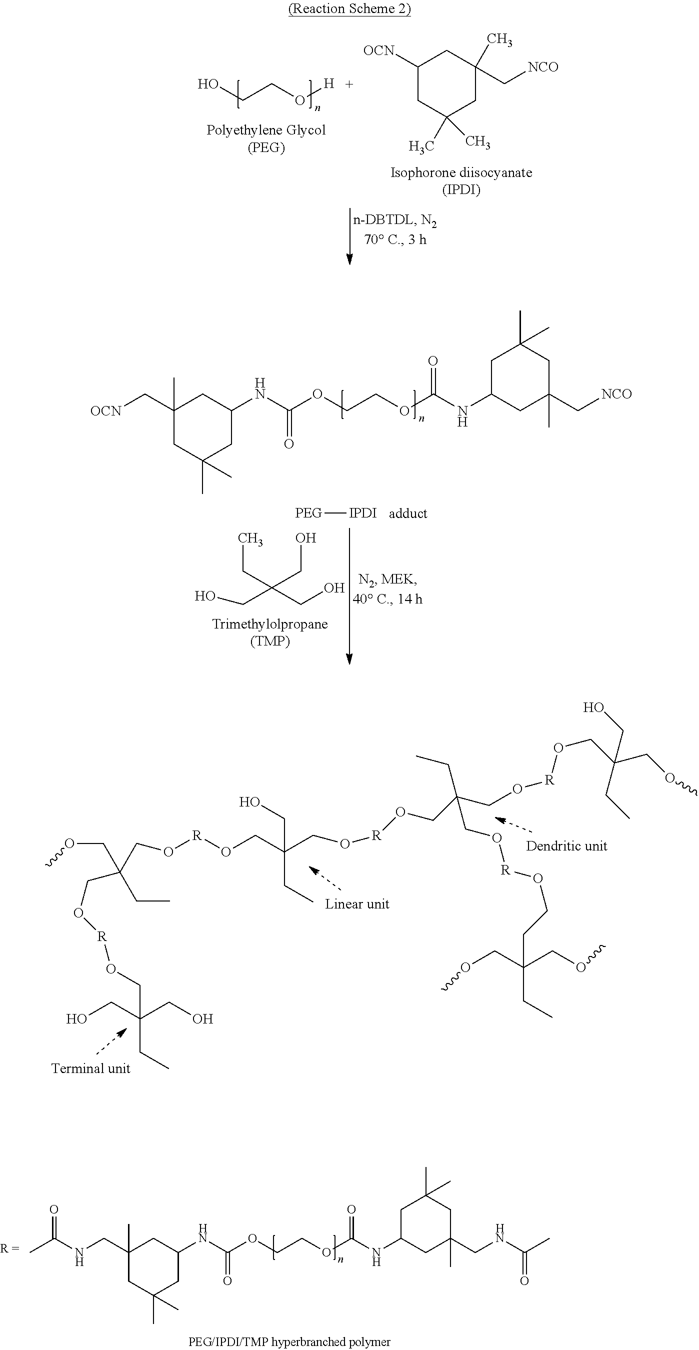

Separately, a desired amount of anode particles (Si, Ge, and Sn, respectively) was added into the reactive mass to form a slurry, which was coated directly onto a primary surface of a Cu foil. The reaction was allowed to continue until completion to form an elastomer matrix-protected anode active layer supported on a Cu foil.

### Example 6: Elastomer Matrix Based on Sulfonated Triblock Copolymer poly(styrene-isobutylene-styrene) or SIBS

Both non-sulfonated and sulfonated elastomers are used to serve as a high-elasticity polymer resin matrix in the present disclosure. The sulfonated versions typically provide a much higher lithium ion conductivity and, hence, enable higher-rate capability or higher power density. The elastomer matrix can contain a lithium ion-conducting additive, an electron-conducting additive, and/or a lithium-ion conducting polymer (basically a polymer electrolyte).

An example of the sulfonation procedure used in this study for making a sulfonated elastomer is summarized as follows: a 10% (w/v) solution of SIBS (50 g) in methylene chloride (500 ml) was prepared. The solution was stirred and refluxed at approximately 40° C., while a specified amount of acetyl sulfate in methylene chloride was slowly added to begin the sulfonation reaction. Acetyl sulfate in methylene chloride was prepared prior to this reaction by cooling 150 ml of methylene chloride in an ice bath for approximately 10 min. A specified amount of acetic anhydride and sulfuric acid was then added to the chilled methylene chloride under stirring conditions. Sulfuric acid was added approximately 10 min after the addition of acetic anhydride with acetic anhydride in excess of a 1:1 mole ratio. This solution was then allowed to return to room temperature before being added to the reaction vessel.

After approximately 5 h, the reaction was terminated by slowly adding 100 ml of methanol. The reacted polymer solution was then precipitated with deionized water. The precipitate was washed several times with water and methanol, separately, and then dried in a vacuum oven at 50° C. for 24 h. This washing and drying procedure was repeated until the pH of the wash water was neutral. After this process, the final polymer yield was approximately 98% on average. This sulfonation procedure was repeated with different amounts of acetyl sulfate to produce several sulfonated polymers with various levels of sulfonation or ion-exchange capacities (IECs). The mol % sulfonation is defined as: mol %=(moles of sulfonic acid/moles of styrene)×100%, and the IEC is defined as the mille-equivalents of sulfonic acid per gram of polymer (mequiv./g).

After sulfonation and washing of each polymer, the S-SIBS samples were dissolved in a mixed solvent of toluene/hexanol (85/15, w/w) with concentrations ranging from 0.5 to 2.5% (w/v). Desired amounts of a lithium salt (e.g., LiNO₃ and lithium trifluoromethanesulfonimide, along with plasticizer, phosphazene or phosphoric acid) were then added into the solution to form slurry samples. The slurry samples were spray-coated onto a pre-made porous anode layer having a porosity of approximately 65%. The slurry got impregnated into pores of the anode layer, followed by removal of the liquid solvent.

### Example 7: High-Elasticity Polysiloxane Matrix-Protected Tin Oxide Particulates

Tin oxide (SnO₂) nano particles were obtained by the controlled hydrolysis of SnCl₄·5H₂O with NaOH using the following procedure: SnCl₄·5H₂O (0.95 g, 2.7 m-mol) and NaOH (0.212 g, 5.3 m-mol) were dissolved in 50 mL of distilled water each. The NaOH solution was added drop-wise under vigorous stirring to the tin chloride solution at a rate of 1 mL/min. This solution was homogenized by sonication for 5 m in. Subsequently, the resulting hydrosol was reacted with H₂SO₄. To this mixed solution, few drops of 0.1 M of H₂SO₄ were added to flocculate the product. The precipitated solid was collected by centrifugation, washed with water and ethanol, and dried in vacuum. The dried product was heat-treated at 400° C. for 2 h under Ar atmosphere.

The high-elasticity polymer matrix for protecting SnO₂ nano particles in the anode layer was based on a double-comb polysiloxane with ethylene oxide side chains, poly[bis(2-(2-(2-methoxyethoxy) ethoxy)-ethoxy)propylsiloxane]. The polymers presented were synthesized via hydrosilylation reactions of the corresponding allyl ethers having the desired ethylene oxide side chain, as outlined in the following reaction:

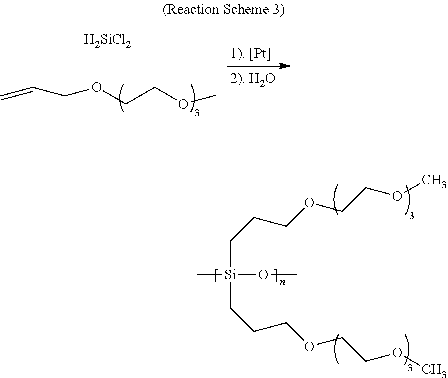

In a representative procedure, the polymer was synthesized as follows: dichlorosilane (40 g, 0.1 mol, 25% solution in xylene) was added to a solution of triethylene glycol allyl methyl ether (41.12 g, 0.2 mol) and chloroplatinic acid (20 mol) in THF (50 mL) at 0° C. The mixture was heated at 60° C. for 4 hours and then acrylonitrile (as a plastic crystal precursor) was added into the mixture. The reaction was allowed to further proceed for 6 h. The polymer solution was impregnated into pores of a porous anode electrode, followed by solvent removal.

The present study led to the following additional observations: The elastomer matrix embedding strategy is surprisingly effective in alleviating the anode expansion/shrinkage-induced capacity decay problems. Such a strategy appears to have significantly reduced or eliminated the possibility of repeated SEI formation and breakage that would otherwise continue to consume electrolyte and active lithium ions. This strategy presumably also acts to preserve the structural integration, avoiding disintegration of the anode electrode.

We claim:

1. An anode active material layer for a lithium battery, said anode active material layer comprising:
a) 50% to 95% by weight of multiple anode active material particles;
b) 0.01% to 30% by weight of a conductive additive; and
c) a high-elasticity polymer having a recoverable tensile strain from 5% to 1,000% when measured without an additive or reinforcement in said polymer and a lithium ion conductivity no less than 10⁻⁶ S/cm at room temperature, wherein said high-elasticity polymer comprises (i) an elastomer or rubber and (ii) a lithium ion-conducting phase comprising plastic crystal domains and/or organic plasticizer domains, wherein:
the elastomer or rubber and the lithium ion-conducting phase, separately or in combination, form a network of lithium ion-conducting pathways;
the amount of conductive additive is sufficient to form a network of electron-conducing pathways that are in electrical contact with the anode active material particles; and
the high-elasticity polymer bonds, encapsulates, embraces, or coats on the surfaces of the anode active material particles and the conductive additive so as to maintain the structural integrity of the anode electrode, preventing interruption of the electron- and lithium ion-conducting pathways when the anode active material particles repeatedly expand and shrink in volume during battery cycling.

2. The anode active material layer of claim 1, wherein the elastomer or rubber is selected from natural polyisoprene, synthetic polyisoprene, polybutadiene, chloroprene rubber, polychloroprene, butyl rubber, butyl acrylic rubber, styrene-butadiene rubber, nitrile rubber, ethylene propylene rubber, ethylene propylene diene rubber, epichlorohydrin rubber, polyacrylic rubber, silicone rubber, polysiloxane, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyurethane, urethane-urea copolymer, poly(phosphazene), a copolymer thereof, a chemically substituted version thereof, a chemical derivative thereof, a sulfonated version thereof, or a combination thereof.

3. The anode active material layer of claim 1, wherein said high-elasticity polymer contains a lithium salt dispersed or dissolved in the elastomer or rubber and/or in the lithium ion-conducting phase.

4. The anode active material layer of claim 1, wherein the high-elasticity polymer comprises from 5% to 95% by weight of plastic crystal domains and/or organic plasticizer domains dispersed in or connected to the elastomer or rubber.

5. The anode active material layer of claim 4, wherein the elastomer or rubber and the plastic crystal or organic plasticizer domain form co-continuous phases exhibiting a lithium-ion conductivity no less than 10⁻⁵ S/cm.

6. The anode active material layer of claim 1, wherein the plastic crystal or organic plasticizer domains comprise a mixture of a lithium salt and an organic plasticizer selected from a fluorinated carbonate, hydrofluoroether, fluorinated vinyl carbonate, fluorinated ester, fluorinated vinyl ester, fluorinated vinyl ether, sulfone, sulfide, nitrile, phosphate, phosphonate, phosphinate, phosphine, phosphine oxide, phosphonic acid, phosphorous acid, phosphite, phosphoric acid, phosphazene compound, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfolane, acetonitrile (AN), acrylonitrile, succino-nitrile, dinitrile, fluoroethylene carbonate (FEC), an ionic liquid solvent, a polymerized version thereof, or a combination thereof.

7. The anode active material layer of claim 6, wherein the polymerized version of the organic plasticizer has a molecular weight less than 10,000 g/mole.

8. The anode active material layer of claim 6, wherein the sulfone or sulfide is selected from vinyl sulfone, allyl sulfone, alkyl vinyl sulfone, aryl vinyl sulfone, vinyl sulfide, a vinyl-containing variant of TrMS, MTrMS, TMS, EMS, MMES, EMES, EMEES, or a combination thereof:

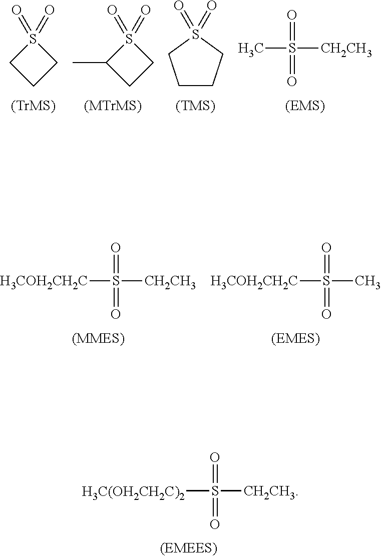

9. The anode active material layer of 8, wherein the vinyl sulfone or sulfide is selected from ethyl vinyl sulfide, allyl methyl sulfide, phenyl vinyl sulfide, phenyl vinyl sulfoxide, allyl phenyl sulfone, allyl methyl sulfone, divinyl sulfone, or a combination thereof, wherein the vinyl sulfone does not include methyl ethylene sulfone and ethyl vinyl sulfone.

10. The anode active material layer of claim 6, wherein the nitrile comprises a dinitrile or is selected from AND, GLN, SEN, succino-nitrile, or a combination thereof:

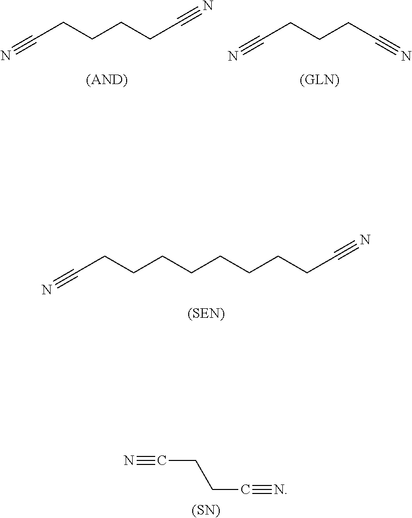

11. The anode active material layer of claim 6, wherein the phosphate is selected from allyl-type, vinyl-type, styrenic-type and (meth)acrylic-type monomers bearing a phosphonate moiety.

12. The anode active material layer of claim 6, wherein the phosphate, phosphonate, phosphonic acid, phosphazene, or phosphite is selected from TMP, TEP, TFP, TDP, DPOF, DMMP, DMNIEM P, tris(trimethylsilyl)phosphite (TTSPi), alkyl phosphate, triallyl phosphate (TAP), a combination thereof, wherein TMP, TEP, TFP, TDP, DPOF, DMMP, DMMEMP, and phosphazene have the following chemical formulae: 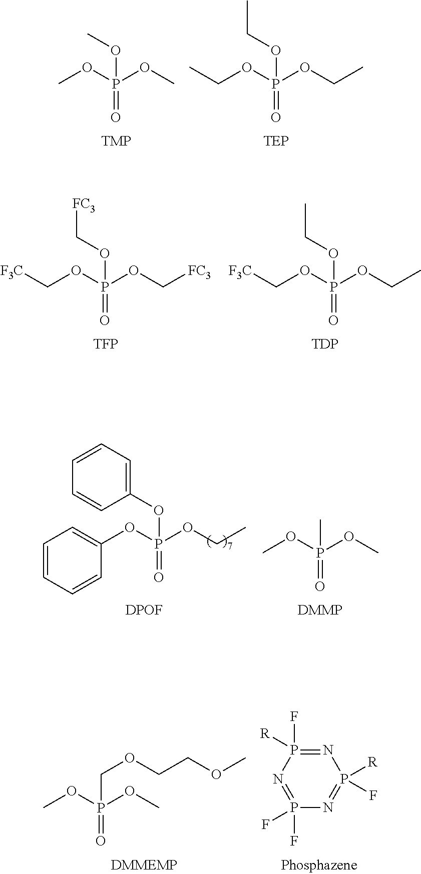
wherein R═H, NH₂, or C₁-C₆ alkyl.

13. The anode active material layer of claim 6, wherein the siloxane or silane is selected from alkylsiloxane (Si—O), alkyylsilane (Si—C), liquid oligomeric silaxane (—Si—O—Si—), or a combination thereof.

14. The anode active material layer of claim 3, wherein said lithium salt is selected from lithium perchlorate (LiClO₄), lithium nitrate (LiNO₃), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, wherein X=F, Cl, I, or Br, R=a hydrocarbon group, x=0-1, y=1-4, or a combination thereof.

15. The anode active material layer of claim 2, wherein said chemically substituted version comprises a H atom being substituted with an alkali cation selected from Li⁺, Na⁺, K⁺, NH₄⁺, or a combination thereof.

16. The anode active material layer of claim 1, wherein the conductive additive comprises a graphite, graphene, or carbon material.

17. The anode active material layer of claim 16, wherein said graphite, graphene, or carbon material is selected from polymeric carbon, amorphous carbon, chemical vapor deposition carbon, coal tar pitch, petroleum pitch, meso-phase pitch, carbon black, coke, acetylene black, activated carbon, graphite particles, carbon particles, meso-phase microbeads, carbon or graphite fibers, carbon nanotubes, carbon nano-fibers, graphitic nano-fibers, graphene sheets, or a combination thereof and said graphite, graphene, or carbon material forms a 3D network of electron-conducting pathways that are in electronic contacts with said anode material particles.

18. The anode active material layer of claim 1, wherein said anode active material is selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles (g) prelithiated versions thereof; (h) particles of lithium or lithium alloy; and (i) combinations thereof.

19. The anode active material layer of claim 1, wherein said anode active material contains a prelithiated Si, prelithiated Ge, prelithiated Sn, prelithiated SnOₓ, prelithiated SiOₓ, prelithiated iron oxide, prelithiated V₂O₅, prelithiated V₃O₈, prelithiated Co₃O₄, prelithiated Ni₃O₄, or a combination thereof, wherein x=1 to 2, wherein said anode active material is lithiated to contain from 0.1% to 54.7% by weight of lithium.

20. The anode active material layer of claim 1, wherein said anode active material particles are porous.

21. The anode active material layer of claim 1, wherein one or a plurality of said particles is coated with a layer of carbon or graphene disposed between said one or said plurality of particles and said high-elasticity polymer.

22. The anode active material layer of claim 1, wherein said high-elasticity polymer comprises a blend, copolymer, crosslinked network, or interpenetrating network of the elastomer or rubber and an electron-conducting polymer comprising chains of a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

23. The anode active material layer of claim 1, wherein the elastomer or rubber forms a mixture or blend with a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, poly(alkylsiloxane), poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyacrylamide, a polyionic liquid, polymerized 1,3-dioxolane, polyepoxide ether, polysiloxane, poly(dimethyl siloxane), poly(alkyl siloxane), poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), chains of ethylene glycol phenyl ether acrylate) (PEGPEA) or ethoxylated trimethyl propyl triacrylate (ETPTA), poly(phosphate), poly(phosphonate), poly(phosphinate), poly(phosphine), poly(phosphine oxide)_poly(phosphonic acid), poly(phosphorous acid), poly(phosphite), poly(phoslphoric acid), poly(phosphazene), a chemical derivative thereof, a copolymer thereof, a sulfonated derivative thereof, or a combination thereof.

24. The anode active material layer of claim 1, wherein the anode active material layer contains therein from 10% to 70% by volume of pores.

25. A lithium battery comprising the anode of claim 1, a cathode, and an electrolyte in ionic contact with said anode and said cathode.

26. The lithium battery of claim 25, further including an ion-conducting separator.

27. A method of producing the anode active layer of claim 1, said method comprising:
(a) dispersing multiple primary particles of an anode active material, a conductive additive, and a resin binder in a liquid medium to form a slurry;
(b) forming the slurry onto at least a surface of an anode current collector and removing the liquid medium to form at least an anode layer bonded to the anode current collector, wherein the anode layer is porous containing pores therein;
(c) preparing a reactive liquid solution comprising (i) a monomer with an initiator or a cross-linkable oligomer, or a polymer with a cross-linking agent and (ii) a desired amount of an organic plasticizer or plastic crystal precursor, and impregnating the reactive liquid solution into pores of the porous anode layer; and
(d) polymerizing the monomer and/or cross-linking the oligomer or polymer to form a high-elasticity polymer comprising an elastomer/rubber and a lithium ion-conducting phase, wherein the high-elasticity polymer embraces the primary particles of the anode active material and the conductive additive to form the anode active layer.

28. A method of producing the anode active layer of claim 1, said method comprising:
a) dispersing multiple primary particles of an anode active material, a conductive additive, and a resin binder in a liquid medium to form a slurry;
b) forming the slurry onto at least a surface of an anode current collector and removing the liquid medium to form at least an anode layer bonded to the anode current collector, wherein the anode layer is porous containing pores therein;
c) preparing a liquid solution comprising a thermoplastic elastomer and an organic plasticizer dissolved or dispersed in a liquid solvent, and impregnating the liquid solution into pores of the porous anode layer; and
d) removing the liquid solvent to precipitate out a high-elasticity polymer comprising the thermoplastic elastomer and domains of plastic crystal or organic plasticizer, wherein the high-elasticity polymer embraces the primary particles of the anode active material and the conductive additive to form the anode active layer.

29. A method of producing the anode active layer of claim 1, said method comprising:
A) dispersing multiple primary particles of an anode active material and a conductive additive in a reactive liquid solution to form a slurry, wherein the reactive liquid solution comprises a plasticizer or plastic crystal precursor and a monomer with an initiator or a cross-linkable oligomer or polymer with a cross-linking agent;
B) forming the slurry onto at least a surface of an anode current collector to form at least a reactive layer comprising the monomer with an initiator or the cross-linkable oligomer or polymer with a cross-linking agent; and
C) polymerizing the monomer or cross-linking the oligomer or polymer to form a high-elasticity polymer that embraces the primary particles of the anode active material and the conductive additive to form the active anode material layer.
